(19) United States
(12) Patent Application Publication
(10) Pub. No.: US 2024/0420300 A1
(43) Pub. Date: Dec. 19, 2024

(54) SYSTEM AND METHOD FOR DETECTING FAILURES IN A SAFETY COUPLING

(71) Applicants: ODYSIGHT.AI LTD., Omer (IL); ISRAEL AEROSPACE INDUSTRIES LTD., Lod (IL)

(72) Inventors: Amir GOVRIN, Ramat Gan (IL); Yekaterina DLUGACH, Mabuim (IL); Shoham BEN SHOSHAN, Meitar (IL)

(21) Appl. No.: 18/742,076

(22) Filed: Jun. 13, 2024

Related U.S. Application Data
(60) Provisional application No. 63/472,665, filed on Jun. 13, 2023.

(51) Int. Cl. G06T 7/00; G06T 7/73

(52) U.S. Cl. CPC G06T 7/0002; G06T 7/73; F16L 2201/10; F16L 2201/20; G06T 2207/20076

(57) ABSTRACT

A system for monitoring a safety coupling, the safety coupling including a visual failure indicator provided by a manufacturer thereof, the system includes: a processing circuitry configured for: receiving image data from the at least one optical sensor, the image data including data of a region of interest of the safety coupling and devoid of the visual failure indicator of the safety coupling; analyzing the image data to detect a change in a relative position between a first and a second part of the safety coupling; evaluating health of the safety coupling by determining whether the detected change is a fault associated with a failure mode of the safety coupling; and outputting an indicator of said health of said safety coupling based on said evaluating.

### CROSS REFERENCE TO RELATED APPLICATION

This application claims the benefit of priority of U.S. Provisional Patent Application No. 63/472,665, filed Jun. 13, 2023, the contents of which are all incorporated herein by reference in their entirety.

### TECHNICAL FIELD

The present disclosure relates generally to systems and methods for detecting failures in a safety coupling, optionally in real time.

### BACKGROUND

Systems in a wide variety of fields, such as, but not limited to, air, land and sea transportation, machinery, gas supply systems, are typically equipped with safety devices, which are of a particular importance in an emergency setting. These safety devices, such as but not limited to, safety couplings, breakaway valves, frangible connectors and the like, are configured to cease liquid and/or gas supply (e.g., fuel supply to an engine) when a failure in the system is detected for the purpose of preventing an explosion, leakage of fluid, and the like. The basic design of breakaway valves and safety couplings includes two configurations, an open configuration, in which a first part and a second part of the breakaway valve are locked/interconnected, thereby allowing uninterrupted and leak-free fluid flow therethrough (during normal system operation), and a closed configuration, wherein the first and the second parts are configured to separate under a predefined load, to allow effectively ceasing the fluid flow therethrough, thereby protecting the system from excessive loads and, in turn, from fluid leaks. For example, European Aviation Safety Agency (EASA) requires installing breakaway couplings or equivalent devices in an aircraft, and in particular, at all tank-to-fuel, tank-to-tank and other interconnecting points in the fuel system wherein structural deformation may lead to undesired fuel release. Further, the EASA dictates that the design of all breakaway valves/couplings installed in aircrafts should, among others, include a visual failure indicator configured to enable visual detection of an anomaly in the breakaway valve.

Currently, a human operator/inspector typically conducts a visual inspection of breakaway valves installed in an aircraft before or after the take-off to detect wear and mechanical failure of the safety couplings. In particular, the human operator/inspector is looking for the visual failure indicator defined by a manufacturer of the safety coupling. Although human operators gain experience in detecting the visual failure indicator, the human operator/inspector effectiveness is significantly hampered by the inability to detect small changes in the structure of the safety couplings, such as changes below 25-50 microns. In addition, human inspection suffers from a lack of continuous inspection, and in particular lack of continuous inspection during operation of the device (e.g., during flight), a limited field of view of the human operator/inspector (e.g., due to limited access and/or inability to visualize the entire perimeter of the breakaway valve/safety coupling). Moreover, visual detection performed by the human operator/inspector is time consuming, and the presence of the human operator in the vicinity of the safety couplings may cause mechanical damage thereto.

### SUMMARY

Aspects of the disclosure, according to some embodiments thereof, relate to systems, methods and a computer program product for monitoring health of safety couplings, specifically prognostic detection of failure modes of a safety coupling which can optionally be performed during operation of the device, optionally in real-time. According to some embodiments there is provided a system and method for predictive based maintenance of a safety coupling.

According to some embodiments, there is provided a system for monitoring a safety coupling, the safety coupling comprising a visual failure indicator provided by a manufacturer thereof, the system includes:
a processing circuitry configured for:
   receiving image data from the at least one optical sensor, the image data including data of a region of interest of the safety coupling and devoid of the visual failure indicator of the safety coupling;
   analyzing the image data to detect a change in a relative position between a first and a second part of the safety coupling;
   evaluating health of the safety coupling by determining whether the detected change is a fault associated with a failure mode of the safety coupling;
   outputting an indicator of said health of said safety coupling based on said evaluating.

According to some embodiments, determining whether the detected change is a fault associated with a failure mode is performed by providing to said processing circuitry image data of said safety coupling and image data related to failure modes of other safety couplings.

According to some embodiments, determining whether the detected change is a fault associated with a failure mode is performed by providing to a trained neural network image data of said safety coupling, wherein the neural network is trained on data related to failure modes of other safety couplings.

According to some embodiments, determining whether the detected change is a fault associated with a failure mode may include classifying the severity of the change.

According to some embodiments, the system may further include determining a probability of the fault to develop into a failure of the safety coupling.

According to some embodiments, the system may further include calculating a trend/rate of the fault in developing into a failure of the safety coupling.

According to some embodiments, an input of the trained neural network may include a set of environmental data of said safety coupling.

According to some embodiments, the set of environmental data changes over time.

According to some embodiments, the set of environmental data may include mileage, velocity of motion, weather conditions, duration of operation, or any combination thereof.

According to some embodiments, the system may further include calculating time and/or mileage to failure and/or expected failure of the safety coupling, depending on environmental data.

According to some embodiments, the image data may include one or more of: an image frame, a portion of an image, a video recording, a sequence of one or more image frames and/or one or more video recordings, or any combination thereof.

According to some embodiments, analyzing may be based, at least in part, on image data of previous faults associated with a failure mode.

According to some embodiments, analyzing the image data may be based, at least in part, on previously obtained image data and/or on reference image data.

According to some embodiments, analyzing the image data may be based, at least in part, on reference non-image data.

According to some embodiments, one of the first and second parts of the safety coupling is static and the other part is dynamic, and wherein analyzing the image data may include taking into account mobility of the dynamic part of the safety coupling.

According to some embodiments, analyzing the image data may include selecting a first point on the first perimeter and a second point on the second perimeter of the safety coupling, and calculating a distance between the first and the second point, to detect the change in the relative position.

According to some embodiments, the system may further include re-selecting at least one of the first and the second points.

According to some embodiments, the change in the relative position may include a parallel displacement between the first perimeter and the second perimeter of the safety coupling.

According to some embodiments, the change in the relative position may include an angular change between the first perimeter and the second perimeter, or sections thereof.

According to some embodiments, the system may further include at least one sub system may include at least one optical sensor configured to capture an image of said region of interest of the safety coupling for processing by said processing circuitry.

According to some embodiments, the region of interest may include: at least a portion of a first perimeter of a first part of the safety coupling and at least a portion of a second perimeter of a second part of the safety coupling.

According to some embodiments, the sub system may further include one or more light sources configured to illuminate the region of interest of the safety coupling.

According to some embodiments, the processing circuitry is configured for determining whether the received image data is usable for detecting a change in the relative position between the first and the second parts of the safety coupling.

According to some embodiments, analyzing the image data may include applying a segmentation step to further analyze only relevant part of the obtained image.

According to some embodiments, analyzing the image data may include applying suppressors to remove identified changes not related to failure modes.

According to some embodiments, when the detected change is not associated with a failure mode, the system may further include classifying the detected change accordingly.

According to some embodiments, the system may further include, based on a predetermined set of rules, outputting a signal indicative of the detected change.

According to some embodiments, the output indicator may further include instructions configured to guide a user for taking appropriate measures.

1. According to some embodiments, the safety coupling is a fuel safety coupling.

According to some embodiments, there is provided a system for monitoring a safety coupling, the safety coupling includes a visual failure indicator provided by a manufacturer thereof, the system includes:
a processing circuitry configured for:
   receiving image data of less than an entire perimeter of the valve from the at least one optical sensor;
   analyzing the image data to detect a change in a relative position between a first and a second part of the safety coupling, wherein the image data is devoid of a visual failure indicator of the safety coupling;
   evaluating health of the safety coupling by determining whether the detected change is a fault associated with a failure mode of the safety coupling,
   outputting an indicator of said health of said safety coupling based on said evaluating.

According to some embodiments, image data of less than an entire perimeter of the valve includes image data of about 10% to about 50% of the entire perimeter of the safety coupling.

According to some embodiments, determining whether the detected change is a fault associated with a failure mode is performed by providing to said processing circuitry image data of said safety coupling and image data related to failure modes of other safety couplings.

According to some embodiments, determining whether the detected change is a fault associated with a failure mode is performed by providing to a trained neural network image data of said safety coupling, wherein the neural network is trained on data related to failure modes of other safety couplings.

According to some embodiments, determining whether the detected change is a fault associated with a failure mode includes classifying the severity of the change.

According to some embodiments, the system may further include determining a probability of the fault to develop into a failure of the safety coupling.

According to some embodiments, the system may further include calculating a trend/rate of the fault in developing into a failure of the safety coupling.

According to some embodiments, an input of the trained neural network includes a set of environmental data of said safety coupling.

According to some embodiments, the set of environmental data changes over time.

According to some embodiments, the set of environmental data may include mileage, velocity of motion, weather conditions, duration of operation, or any combination thereof.

According to some embodiments, the system may further include calculating time and/or mileage to failure and/or expected failure of the safety coupling, depending on environmental data.

According to some embodiments, the image data may include one or more of: an image frame, a portion of an image, a video recording, a sequence of one or more image frames and/or one or more video recordings, or any combination thereof.

According to some embodiments, analyzing may be based, at least in part, on image data of previous faults associated with a failure mode.

According to some embodiments, analyzing the image data is based, at least in part, on previously obtained image data and/or on reference image data.

According to some embodiments, analyzing the image data is based, at least in part, on reference non-image data.

According to some embodiments, one of the first and second parts of the safety coupling is static and the other part is dynamic, and wherein analyzing the image data may include taking into account mobility of the dynamic part of the safety coupling.

According to some embodiments, analyzing the image data may include selecting a first point on the first perimeter and a second point on the second perimeter of the safety coupling, and calculating a distance between the first and the second point, to detect the change in the relative position.

According to some embodiments, the system may further include re-selecting at least one of the first and the second points.

According to some embodiments, the change in the relative position may include a parallel displacement between the first perimeter and the second perimeter of the safety coupling.

According to some embodiments, the change in the relative position may include an angular change between the first perimeter and the second perimeter, or sections thereof.

According to some embodiments, the system may further include at least one sub system including at least one optical sensor configured to capture an image of said region of interest of the safety coupling for processing by said processing circuitry.

According to some embodiments, the region of interest may include:
at least a portion of a first perimeter of a first part of the safety coupling and
at least a portion of a second perimeter of a second part of the safety coupling.

According to some embodiments, the sub system may further include one or more light sources configured to illuminate the region of interest of the safety coupling.

According to some embodiments, the processing circuitry is configured for determining whether the received image data is usable for detecting a change in the relative position between the first and the second parts of the safety coupling.

According to some embodiments, analyzing the image data may include applying a segmentation step to further analyze only relevant part of the obtained image.

According to some embodiments, analyzing the image data may include applying suppressors to remove identified changes not related to failure modes.

According to some embodiments, when the detected change is not associated with a failure mode, further comprising classifying the detected change accordingly.

According to some embodiments, the system may further include, based on a predetermined set of rules, outputting a signal indicative of the detected change.

According to some embodiments, the output indicator may further include instructions configured to guide a user for taking appropriate measures.

According to some embodiments, the safety coupling is a fuel breakaway valve.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, optional elements/components and optional stages may be included within dashed boxes.

In the figures:

FIG. 1 shows a block diagram of a system for monitoring a safety coupling, according to some embodiments;

FIG. 2 shows a flowchart of a computer implement method for monitoring a safety coupling, according to some embodiments;

FIG. 3A shows a schematic illustration of a side view of a safety coupling, according to some embodiments;

FIG. 3B which shows a schematic illustration of a side view of the safety coupling of FIG. 3A in a first configuration exposing a visual failure indicator, according to some embodiments;

FIG. 3C which shows a schematic illustration of a side view of the safety coupling of FIG. 3A in a second configuration exposing a visual failure indicator, according to some embodiments;

FIG. 4A shows a schematic illustration of a perspective side view of a system for monitoring a safety coupling, according to some embodiments;

FIG. 4B shows a schematic illustration of a projection of a region of interest captured by the system of FIG. 4A, according to some embodiments;

FIG. 4C shows a schematic illustration of a perspective side view of a monitored safety coupling, according to some embodiments;

FIG. 4D shows a schematic illustration of a projection of a region of interest captured of the safety coupling of FIG. 4C, according to some embodiments;

FIG. 4E shows a schematic illustration of the determination of a region of interest of a system for monitoring a safety coupling, according to some embodiments; and

FIG. 5 schematically illustrates a system for monitoring health of safety couplings, according to some embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

An aspect of some embodiments of the invention relates to prognostic health monitoring (PHM) of a safety coupling and/or to condition based maintenance (CBM) of a safety coupling. As used herein, according to some embodiments, the terms “safety coupling”, “breakaway valve” and “breakaway coupling” are used interchangeably and refer to any type of breakaway valves, safety couplings or frangible connector, such as but not limited to, fuel breakaway valves, hydraulic breakaway valves, shut-off valves or any other safety coupling, frangible connector or device. According to some embodiments, the safety coupling is specifically designed to break at controlled locations on impact in order to shut off fluid flow such as from fuel lines or tanks. The safety coupling is configured to seal off and stop fluid (i.e., liquid or gas) flow when a load exceeding a predetermined value is applied thereto (also referred herein as “separation load”), while allowing uninterrupted fluid flow therethrough during routine operation. According to some embodiments, the safety coupling may include any type of valve/coupling configured to be separated, such that the safety coupling will break apart and seal off fluid supply/flow therethrough. It may be understood by skilled in the art that safety couplings may be employed in various devices, machines or systems in a wide variety of fields, such as, but not limited to, air, land and sea transport systems, machinery, gas supply systems, piping systems, and any other systems. As a non-limiting example, safety coupling may refer to a coupling configured to be installed on a fuel line, wherein a first end of the fuel line is connected to a fuel tank and a second end of the fuel line is connected to an engine of a machine/system. A safety coupling according to some embodiments includes a visual failure indicator.

As used herein, according to some embodiments, the term “visual failure indicator” may refer to any visual indicator provided by a manufacturer of a safety coupling indicating a failure thereof. According to some embodiments, the visual failure indicator is configured to be revealed/exposed during failure or failure development of the safety coupling. Put differently, in some embodiments, during normal service/operation of the safety coupling, the visual failure indicator is concealed from a human operator/inspector. As a non-limiting example, the visual failure indicator may include, among others, a color change.

According to some embodiments, there are provided systems, methods and computer programs for detection and identification of change(s) in a relative position (e.g., displacement or deviation) between a first and a second part of a safety coupling. According to some embodiments, the detected changes associated with a fault may be identified based on comparing a current image data of the safety coupling to reference data, such as reference image data or other baseline data.

As used herein, according to some embodiments, the term “change” may refer to any type of a visually detectable, typically external, change in at least one image received by the system from at least one optical sensor, relative to reference data. According to some embodiments, the reference data may include a previously obtained image data (such as, for example, image data obtained at to, image data received by the system at one or more preceding time points, a base-line image data (e.g., provided by a manufacturer of a safety coupling, obtained from a database, and the like), or any other suitable reference image data. According to some embodiments, a reference image data may be obtained from image data of the actual safety coupling being monitored by the system, or to image data obtained from similar or different types of safety coupling(s).

According to some embodiments, the reference data is non-image data, such as a predefined distance between two parts of the safety coupling, or a specified parallelism or angle between two parts of the safety coupling. Optionally, both reference image data and reference non-image data are used.

According to some embodiments, a change may refer to any type of a visually detectable, typically external, change/variation in the safety coupling, relative to a selected reference (which may be, for example, a previous time point, a base-line data, data of a control valve, etc.). According to some embodiments, the change may refer to a change in a relative position (displacement) between a first and a second part of the safety coupling (e.g., deviation in a position of the first and/or the second part of the safety coupling). According to some embodiments, the change may refer to a change in a relative position (displacement) between a first perimeter (or a portion thereof) of the first part and a second perimeter (or a portion thereof) of the second part of the safety coupling. Each possibility is a separate embodiment.

According to some embodiments, detection of a change may further be based on background/environmental changes in the image data, which are not directly related to or indicative of structural changes of the safety coupling. According to some embodiments, the background/environmental changes may include an external feature, such as but not limited to, dust, dirt, grease, an insect, and the like, that can induce changes in image data, but are not necessarily indicative of changes in structure of the safety coupling.

According to some embodiments, the system is adapted to differentiate between environmental changes on the optical sensor and environmental changes in the imaged objects. For example, the system may identify dust or droplets on the optical lens and optionally alert a user to clean the image lens or initiate automatic lens cleansing. The system may also identify dirt on the imaged object, such as a part of the valve and optionally alert the user to clean the valve or initiate automatic cleansing of the valve.

In some embodiments, the system may differentiate between dirt on the optical sensor and dirt on the valve by using any method known in the art. Optionally, the system may analyze one or more of color, blur and boundaries of a change in an area of one or more images. For example, when the area of the change does not have clear geometrical boundaries, or based upon a gray color in the image, the system may identify dirt or droplets on the optical sensor, whereas clear geometrical boundaries may indicate droplets on the valve. Optionally, upon detection of dirt on the optical sensor, instructions for cleaning maintenance are issued or an automatic cleaning procedure is initiated.

According to some embodiments, the disclosed system and method may detect a change within a region of interest of a safety coupling. According to some embodiments, the region of interest may include at least a portion of a first perimeter of a first part of the safety coupling, and at least a portion of a second perimeter of a second part of the safety coupling. According to some embodiments, the region of interest may include at least a portion of a first perimeter of a first part of the safety coupling, at least a portion of a second perimeter of a second part of the safety coupling, and an area therebetween.

According to some embodiments, the change detected by the herein disclosed system and method may be different than a visual failure indicator of the safety coupling. As a non-limiting example, the visual failure indicator may include a colour change (e.g., an exposure of a new colour in the region of interest of the safety coupling), while the detected change may include a parallel displacement between the first and the second perimeters of the first and the second parts, respectively, of the safety coupling. Accordingly, the discloses system has a potential advantage of detecting a change even in a dirty safety coupling (e.g., safety coupling covered with grease, dust, oil, or any other liquid/solid contaminations), which can otherwise prevent or hinder the detection of the visual failure indicator upon exposure thereof. For example, in some embodiments, a change is detected based on distance measurement between perimeters or edges of two parts of a valve which can be identified in dirty valves, or where upon detection of dirt in part of the image data different reference points in the image are chosen.

In some embodiments, detection of a change may be verified by detection of additional sensors and/or detection of additional failure modes. For example, the system may detect leakage from the safety coupling using the same or other optical sensor to verify a potential detection of failure mode by deviation of a part of the valve. Alternatively or additionally, the system may use detection of other type of sensors to detect leakage (e.g., humidity sensor) or vibrations (e.g. vibration sensor) to verify a potential failure mode detected by the system.

In addition, a potential benefit of the system and methods disclosed is detecting a change in a valve before exposure of a visual indicator of the valve. According to some embodiments, the change may be detected by the disclosed system while the visual failure indicator is concealed (i.e., before the visual indicator is revealed). According to some embodiments, the change may be detected by the disclosed system in image data covering less than the entire perimeter of the valve wherein no visual indicator is revealed while the visual failure indicator is revealed only in non-imaged portions of the circumference of the safety coupling.

According to some embodiments, the change may be classified as a fault associated with a failure mode (e.g., a change that may or is likely to develop into a failure) or as a fault not associated with a failure mode, i.e., a harmless change, as described in greater detail elsewhere herein.

In some embodiments, the system and method analyse image data of only a portion of a perimeter/circumference of a safety coupling. According to some embodiments, the portion of the perimeter may include about 2-50%, about 5% or less, about 10% or less, about 20% or less, about 30% or less, about 40% or less, about 50% or less of the perimeter/circumference of the safety coupling or any intermediate range. Each possibility is a separate embodiment.

As used herein, according to some embodiments, the term “fault associated with a failure mode” may refer to an anomaly or undesired effect or process in a safety coupling that may or may not develop into a failure of the safety coupling but requires follow-up, to analyze whether the valve needs to be repaired or replaced, whether the monitored valve exhibits unusual appearance or functionality. According to some embodiments, the fault may include, among others, structural deformation, surface deformation, a displacement between a first and a second part of the safety coupling (e.g., a change in position and/or a change in an angle between the first and the second part of the safety coupling), an alignment change (e.g., between the first and the second part of the safety coupling), a position change of the safety coupling, a crack, crack propagation, a defect, inflation, bending, wear, corrosion, leakage, a change in color, a change in appearance, repetitive movement of the first and/or the second portion of the safety coupling, and the like, or any combination thereof.

As used herein, according to some embodiments of the invention, the term “failure” may refer to any problem that can occur to a part of a safety coupling, wherein the problem disables usage of the valve, endangers the machine in which the valve is installed, a person or an object in the vicinity of the machine, or the like. In some embodiments, the term failure encompasses also exposure of a visual failure indicator provided by a manufacturer of the valve.

As used herein, according to some embodiments of the invention, the term “failure mode” is to be widely construed to cover any manner in which a fault or failure may occur, such as structural deformation, surface deformation, a displacement between a first and a second part of the safety coupling (e.g., a change in position and/or a change in an angle between the first and the second part of the safety coupling), an alignment change (e.g., between the first and the second part of the safety coupling), a position change of the safety coupling, a crack, crack propagation, a defect, inflation, bending, wear, corrosion, leakage, a change in color, a change in appearance, repetitive movement of the first and/or the second portion of the safety coupling, and the like, or any combination thereof. It is appreciated that a part may be subject to a plurality of failure modes, related to different characteristics or functionalities thereof. For example, parts of the valve may be displaced as well as bent.

According to some embodiments, a failure mode refers to the scale/range developing between a fault and an actual failure, i.e., the state of the detected change (wherein initially the detected change is defined/determined as a fault) ranging from a fault into the actual failure. According to some embodiments, the failure mode may include, among others, a detectable (e.g., exposed) visual failure indicator of the safety coupling.

For example, a failure mode of the safety coupling may be defined as a displacement (or a propagation of the displacement) between a first perimeter of a first part and a second perimeter of a second part of the safety coupling. In this example, the displacement of a failure is larger than the displacement of the fault. According to some embodiments, a displacement is classified as a fault when the displacement is smaller than a predefined distance of an associated failure. Put differently, in some embodiments, the size of the displacement differentiates between fault and failure, and said size ranges in the failure mode between fault and failure states. For example, a failure may be classified as a predefined distance of about 0.6 mm-about 0.5 mm between a first part and a second part of a safety coupling, and a fault associated with the failure may be, for example, about 0.3 mm-about 0.2 mm, about 0.2 mm-about 0.1 mm, about 0.1 mm-about 0.05 mm, about 0.05 mm or less.

According to some embodiments, a fault may be associated with known failure modes, e.g., failure modes defined by a manufacturer of the safety coupling (such as visual failure indicator, change in predefined distance or alignment between two parts of the valves), or other failure modes, e.g., previously learned failure modes from analysis of failure of same of different safety couplings. Alternatively, or additionally, the fault may include previously unknown (or undefined) failure modes (e.g., failure modes not provided by a manufacturer of the safety coupling or not previously stored in an associated database).

As used herein, according to some embodiments of the invention, the term “trend” or “trend of failure mode” is to be widely construed to cover any behavior over time of a fault, or a failure mode, when or under what circumstances the fault will turn into a failure. The trend is optionally associated with additional circumstances such as environmental conditions, usage characteristics of the machine in which the valve is installed, characteristics of a user of a machine, or the like.

Optionally, in some embodiments, the system and method may analyze a trend/rate of change of the fault associated with the failure mode in developing into a failure, and output the trend/rate of change. In some exemplary embodiments, the system may be configured to calculate the rate of change of the fault, and the time until the detected change associated with the fault (e.g., a 0.1 mm displacement) will develop into a failure (e.g., a 0.5 mm displacement).

In some embodiments, the system and method determine whether the detected change is a fault associated with a failure mode in a safety coupling, before the failure mode propagates or develops into a failure. Optionally, in some embodiments, the system detects or identifies a fault associated with a failure mode before the detectability of a visual failure indicator provided by a manufacturer of the safety coupling, for example by analyzing other conditions that specified by the visual indicator. According to some embodiments, the detection of the change may optionally be performed during operation of a device in which the safety coupling is installed, and alerts may be provided in real time. According to some embodiments, there is provided a system for detecting and analyzing changes in parts, elements, or portions of a safety coupling.

According to some embodiments, the system receives image data from at least one optical sensor positioned on or in vicinity of the safety coupling, the at least one optical sensor having a field of view configured to capture one or more images of at least a portion of the safety coupling.

According to some embodiments, the system may further include a processing circuitry including at least one processing circuitry, the processing circuitry is configured for: receiving image data from the at least one optical sensor, analyzing the image data to detect a change in at least one part of the safety coupling. Optionally, the change is in a relative position (e.g., displacement or deviation) between a first part and a second part of the valve. Optionally, the processing circuitry is further configured for determining whether the detected change is a fault associated with a failure mode. Optionally, in some embodiments, the system and method identify the fault associated with a failure mode prior to detectability of the visual failure indicator provided by a manufacturer of the safety coupling. In some embodiments, the processing circuitry is further configured for outputting a signal indicative of the fault associated with the failure mode and/or information related thereto, such as, for example, trend of fault or failure mode, as further described elsewhere herein.

According to some embodiments, there are provided systems and methods for non-destructive detection of a change of at least one parts of one or more safety couplings in real time, wherein the detection is performed by analysis of image data and thus does not interfere with the functioning or structure of the monitored valve or surrounding components.

An aspect of some embodiments of the invention relates to ongoing monitoring of the health of a safety coupling. The term “ongoing” according to some embodiments may refer to continuous monitoring, to periodic monitoring sessions scheduled over time, to occasional monitoring sessions over time, or the like.

In some embodiments, the disclosed system may continuously or occasionally receive images of one or more sections/parts and/or elements of a safety coupling and detect changes (such as but not limited to, displacements, deviations or other structural changes) of parts of safety couplings in the images. According to some embodiments, the system is configured to detect at least one change in parts of a safety coupling during operation of an industrial system/machine based on one or more images captured by at least one optical sensor. According to some embodiments, the system is configured to analyze the change, e.g., by a computer vision, image processing, machine learning techniques, artificial intelligence and the like, or any combination thereof.

In some embodiments, the disclosed system is configured to analyze images from at least one optical sensor to monitor a substantially complete circumference/perimeter of the safety coupling. According to some embodiments, the portion of the circumference/perimeter of the safety coupling that is monitored may be based, at least in part, on a field of view of the at least one optical sensor, and/or a distance between the safety coupling and the optical sensor, and/or a position of the at least one optical sensor. According to some embodiments, the at least one optical sensor may be movable, thereby allowing capturing the substantially complete circumference/perimeter of the safety coupling or at least 70%, 80% or 90% thereof.

According to some embodiments, the optical sensor may be stationary and optionally cover less than the entire circumference/perimeter of the (circular) valve. Optionally, two or more optical sensors are provided for covering a larger portion of the circumference of the valve, for example at least 70%, 80% or 90% or substantially the entire circumference of the valve.

In some embodiments, the disclosed system further enables ongoing health monitoring and detection of faults associated with failure modes in locations that may be inaccessible during operation of the industrial system/machine or may be potentially damaged due to the presence of a human inspector. Optionally, the disclosed system is further configured to detect faults associated with failure modes in real time during operation (e.g., during flight), and optionally during idle times, without interfering or damaging the safety coupling or of other devices positioned in vicinity thereof. Optionally, the disclosed system further enables ongoing detection of faults associated with failure modes in locations that may be hazardous to a human inspector, such as but not limited to, safety devices positioned in vicinity to areas with high temperature, high pressure, and/or high-radiation areas. In other embodiments, the disclosed system reduces the need for maintenance by human technicians.

According to some embodiments, the disclosed system may detect faults associated with failure modes in various types of safety couplings, such as but not limited to, safety couplings made of various types of materials, such as, metallic and non-metallic, magnetic and non-magnetic, conductors and non-conductors, transparent, non-transparent and/or opaque, and the like. According to some embodiments, the disclosed system is configured to detect and/or monitor faults associated with failure modes of safety couplings mounted on rigid and/or flexible pipes/tubes. Further, in some embodiments, the disclosed herein system is applicable for detection of faults associated with failure modes in various types of colors, textures and forms of the safety couplings (e.g., different perimeter shapes).

According to some embodiments, the system includes at least one optical sensor configured to capture one or more images of at least a portion of a safety coupling. According to some embodiments, the at least one optical sensor may include at least one camera. According to some embodiments, at least one optical sensor may include a charge-coupled device (CCD). According to some embodiments, at least one optical sensor may include an active-pixel sensor (CMOS sensor). According to some embodiments, the at least one optical sensor may include any one or more of a light-emitting diode (LED) and a complementary metal-oxide-semiconductor (CMOS) sensor (or an active-pixel sensor), a photodetector (e.g. IR sensor, visible light sensor, UV sensor), distance measurement sensor such as a Lidar sensor, or any combination thereof.

According to some embodiments, the at least one optical sensor may include one or more lenses. According to some embodiments, the one or more lenses may include optical lens. According to some embodiments, the at least one optical sensor may include one or more light reflecting components, such as a mirror, prism, and the like, or any combination thereof.

According to some embodiments, the at least one optical sensor may include one or more light sources configured to illuminate a region of interest of the safety coupling. According to some embodiments, the light source(s) include one or more of: a light bulb, a light-emitting diode (LED), a laser, an electroluminescent wire, and light transmitted via a fiber optic wire or cable (e.g. from an LED coupled to the fiber optic cable). Other types of light sources may also be suitable.

According to some embodiments, the light source may emit visible light, infrared (IR) radiation, near IR radiation, ultraviolet (UV) radiation or light in any other spectrum or frequency range.

According to some embodiments, the at least one optical sensor may be configured to move/rotate (e.g., movements dictated by a processing circuitry of the system). As a non-liming example, the at least one optical sensor may be positioned on a bracket which is fixed relative to the safety coupling (e.g., on a holder attached to a bracket). According to some embodiments, the at least one optical sensor may be movable along the holder. According to some embodiments, the holder may rotate across the bracket, thereby rotating the at least one optical sensor. According to some embodiments, a user may provide an input (e.g., instructions) via a user interface (UI) to move/rotate the at least one optical sensor to a desired position. According to some embodiments, a processing circuitry of the system may automatically or semi-automatically determine/change the position of the at least one optical sensor so as to enhance image capturing.

According to some embodiments, the at least one optical sensor may capture each of the one or more images while being at a static position. According to some embodiments, the at least one optical sensor may capture the one or more images while being moved/rotated, such that a series of images is captured. Optionally, the processing circuitry is configured for integrating the series of images to form a combined image including a wide-ranged image.

According to some embodiments, the system includes a processing circuitry, wherein the processing circuitry includes at least one processor. According to some embodiments, the processing circuitry is configured to receive image data from the at least one optical sensor, execute program instructions (or one or more codes), as elaborated further herein, and output a signal indicative of the status of the safety coupling. Optionally, the processor outputs an indication of a fault identified in the safety coupling. In some embodiments, the processor outputs a trend of the fault indicating when maintenance is required. Optionally, the output includes circumstances or a time range at which the fault will develop into failure.

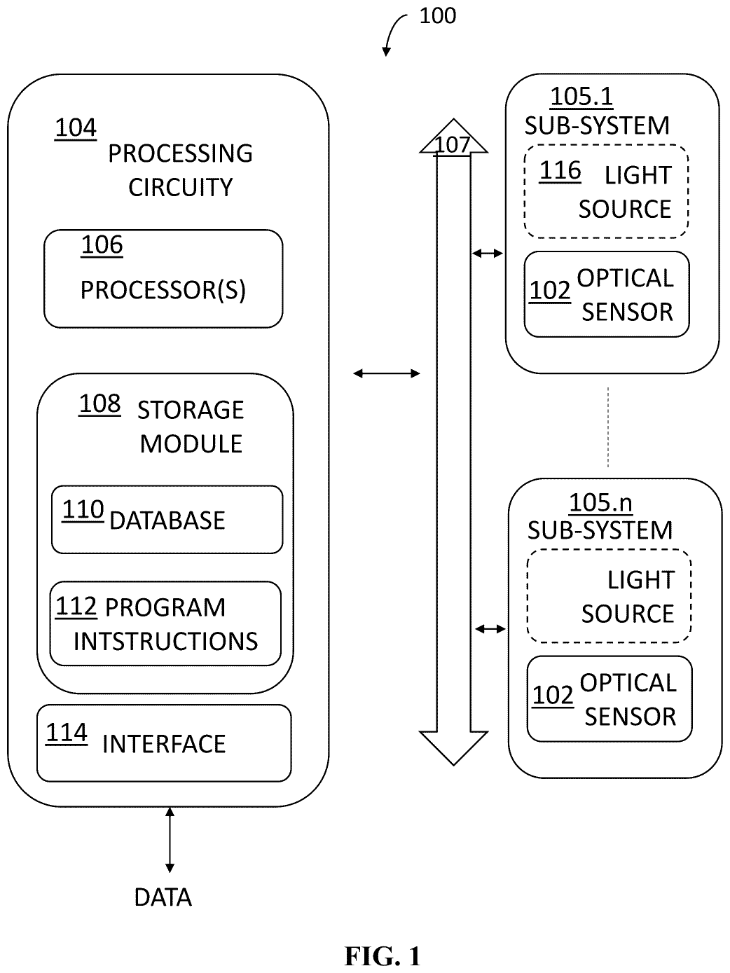

Reference is made to FIG. 1, which shows a block diagram of a system 100 for monitoring a safety coupling, according to some embodiments.

According to some embodiments, system 100 for monitoring health of a safety coupling may be installed in a device, such as transportation systems (e.g., aircraft), gas supply systems, machinery, industrial systems, or any other type of systems conducting, transferring, producing or otherwise using fluids (e.g., gases or liquids), or connected to fluid lines.

According to some embodiments, system 100 is configured to monitor the safety coupling in real time. According to some embodiments, system 100 is configured to provide ongoing monitoring the safety coupling. According to some embodiments, system 100 is configured to monitor the safety coupling during operation of the device (e.g., during flight). Alternatively, or additionally, in some embodiments, system 100 is configured to monitor the safety coupling during idle times (e.g., pre- or post-flight). Advantageously, system 100 may be compatible with international aviation standards, such as dictated by European Aviation Safety Agency (EASA) and/or other worldwide agencies, thereby system 100 may be installed in an aircraft during flight and monitor safety couplings installed in the aircraft.

According to some embodiments, system 100 includes a processing circuitry 104, including one or more processors 106, a user interface 114 and a storage module 108. In accordance with some embodiments, system 100 further includes one or more one or more sub-systems 105.1-105.n which provide the image data used to monitor the safety coupling. According to some embodiments, sub-systems 105 may be installed in a machine including a safety coupling. Optionally, optical sensors 105.1-105.n provide the image data to the processor over databus 107 or any other communication pathway used to transfer data.

According to some embodiments, each of one or more sub-systems 105.1-105.n include at least one optical sensor 102 and optionally one or more light sources 116.

According to some embodiments, the one or more light sources 116 are configured to illuminate a region of interest of the safety coupling. According to some embodiments, the light source(s) include one or more of: a light bulb, a light-emitting diode (LED), a laser, an electroluminescent wire, and light transmitted via a fiber optic wire or cable (e.g. from an LED coupled to the fiber optic cable). Other types of light sources may also be suitable.

Optionally, processing circuitry 104 controls one or more of:
1) The direction of illumination of the light source;
2) The duration of illumination;
3) The frequency of illumination;
4) The illumination intensity;
5) Switching the light source on or off;
6) The color of the illumination; and
7) Lighting synchronization with, but not limited to: Frame per second of the camera, vibration frequency of the monitored component, etc.

Optionally, in some embodiments, the parameters of the light source is adjusted based on analysis of previous images. For example, when an image is detected by processing circuitry as being dazzled, parameters of the light source may be adjusted by the processor. Alternatively, in some embodiments, when a dazzled image is detected, the processor may instruct movement of the optical sensor to image the safety coupling from a different direction or, when more than one optical sensor is provided, to image the safety coupling by another sensor.

Optionally, when a dazzled image is detected, the processor may cancel or adjust the AGC algorithm (Automatic Gain Control), and the Gain parameters as well as all other camera parameters like FPS, exposer time, etc., can be manually controlled by the user.

Alternatively, or additionally, in some embodiments, the intensity, wavelength and/or direction of one or more light sources 116 may be controlled/tailored by a user, e.g., via a user interface 114. Consequently, in some embodiments, enabling manually controlling and changing various system parameters via user interface 114, such as changing/defining the position of at least one optical sensor 102, changing lighting parameters of one or more light sources 116, and the like, or a combination thereof.

According to some embodiments, the light source may emit visible light, infrared (IR) radiation, near IR radiation, ultraviolet (UV) radiation or light in any other spectrum or frequency range.

In some embodiments, the optical sensor is an embedded sensor having a processing unit integrated with the sensor for controlling the sensor and or illumination parameters.

According to some embodiments, at least one optical sensor 102 may have a field of view which includes/covers at least a portion of the safety coupling. Optionally, sub-systems 105 may be installed on the safety coupling using a mount, bracket or the like. Optionally, two or more of subsystems 105 are installed on the same safety coupling. According to some embodiments, each of processing circuitry 104, user interface 114, and/or storage module 108 may be positioned/installed remotely from sub-system 105. Each possibility is a separate embodiment. As a non-limiting example, user interface 114 may be positioned remotely in an operation room of a machine/industrial setting, and processing circuitry 104 may be positioned in vicinity to sub-system 105 (i.e., in vicinity to the safety coupling).

According to some embodiments, at least one optical sensor 102 may be detachably attached or permanently fixed to the safety coupling and/or to a component in vicinity to the safety coupling. According to some embodiments, at least one optical sensor 102 may be replaceable (e.g., replaced due to malfunction). According to some embodiments, as further detailed below herein, at least one optical sensor 102 may be movable (e.g., may move along a predefined direction along a limited distance). According to some embodiments, at least one optical sensor 102 may be rotatable. Movement of the sensor and/or the lighting source can be implemented using different types of mechanisms for example any type of one or more of mechanical, electro-mechanical, electro-chemical Shape Memory Alloy, piezoelectric, magnetic and pneumatic mechanisms.

According to some embodiments, moving/rotating at least one optical sensor 102 is controlled by processing circuitry 104 during monitoring of the safety coupling in order facilitate capturing one or more images at desired angles/positions relative to a region of interest of the safety coupling. According to some embodiments, moving at least one optical sensor 102 during monitoring of the safety coupling may minimize image artifacts, such as reflection, light streaks, flash glare, and the like, from the captured one or more images. According to some embodiments, at least one optical sensor 102 may be stationary (i.e., non-movable).

According to some embodiments, at least one optical sensor 102 is configured to capture one or more images of at least a portion of the safety coupling, as elaborated elsewhere herein. According to some embodiments, the one or more images may include one or more of: an image frame, a video recording, a sequence of one or more image frames and/or one or more video recordings, or any combination thereof. According to some embodiments, the image data may include the one or more images captured by the at least one optical sensor 102 and transmitted into electrical signals.

According to some embodiments, at least one optical sensor 102 may include at least one camera. According to some embodiments, at least one optical sensor 102 may include a charge-coupled device (CCD). According to some embodiments, at least one optical sensor 102 may include an active-pixel sensor (CMOS sensor). According to some embodiments, at least one optical sensor 102 may include at least one image sensor.

According to some embodiments, at least one optical sensor 102 may be configured to detect light reflected from the safety coupling. It is known to one skilled in the art that surfaces with different texture reflect light differently. Hence, in some embodiments, light reflected from a properly functioning safety coupling may differ from the light reflected from a change present on the safety coupling, such as from an exposed region due to displacement of at least a portion of a first part and/or at least a portion of second part of the safety coupling. Furthermore, changing the wavelengths, intensity, and/or directions of a light source used by the system (as detailed below), may intensify this phenomenon. In such instances, processing circuitry 104 may adjust the light source, to accommodate various environmental or any other settings.

According to some embodiments, one or more processors 106 may be configured to process the image data received from at least one optical sensor 102.

According to some embodiments, processing circuitry 104 may be positioned/installed in vicinity to sub-system(s) 105 (e.g., in vicinity to at least one optical sensor 102). According to some embodiments, processing circuitry 104 may be positioned/installed at a different location, away from the at least one optical sensor 102, wherein processing circuitry 104 is connected with a cable and/or wirelessly connected with the at least one optical sensor 102. According to some embodiments, processing circuitry 104 may be positioned/installed in a machine in which the safety coupling is installed. In some embodiments, the processing circuitry may be positioned at a remote location (for example, at a control center), in which case it is remotely functionally connected to sub system(s) 105.

According to some embodiments, system 100 includes a storage module 108 in communication with at least one processor 106. According to some embodiments, storage module 108 includes database 110 configured to store data associated with system 100. According to some embodiments, storage module 108 may include a cloud platform, whereby results of the analysis performed by the processor are also configured to be provided to a cloud platform, or any other remote server. According to some embodiments, database 110 may include one or more of previously obtained image data, reference image data, output messages, environmental data/parameters, operation parameters, user inputted data, training sets (e.g., input and label for neural network (NN) training), data of failure modes of safety couplings, data of faults associated with a failure mode, and the like, or any combination thereof.

In some embodiments, at least some of the data in the database is received from an external source through interface 114, optionally in real time.

According to some embodiments, the reference data may include, among others, previously obtained image data from the optical sensor, previously obtained image data from a different system (e.g., via the cloud platform or any other shared platform) or from a different valve in the same machine, manufacturer images, image data including faults that are likely to develop into failures, examples of changes that are unlikely to develop into failures (i.e., harmless changes), image data including properly functioning safety couplings, and the like, or any combination thereof.

According to some embodiments, environmental data/parameters may include, among others, weather conditions, such as temperature, wind, humidity levels, pressure, precipitation, and the like. According to some embodiments, the environmental parameters may include background and/or any surroundings of the safety coupling, such as image data of the surrounding areas/background around the safety coupling. According to some embodiments, the environmental data/parameters may include, among others, operational parameters of the machine wherein the breakaway away is installed, such as flight and/or operation duration, idle time duration, mileage, velocity of motion and the like or any combination thereof. According to some embodiments, the environmental data/parameters may include a diverse set of environmental parameters, such as environmental parameters that may change over time.

According to some embodiments, the environmental data/parameters may be provided/inputted by a user (e.g., via user interface 114). According to some embodiments, the environmental data/parameters may be received by system 100 by processing circuitry 104 from other sensors in the system, such as temperature sensors, pressure sensors, vibration sensors or others. As a non-limiting example, processing circuitry 104 may be in communication with control/operation system/user interface of the device. Alternatively, or additionally, the environmental data/parameters may include statistical data received from other systems (e.g., statistical data of other devices).

According to some embodiments, storage module 108 includes one or more program instructions 112 configured to be executed by one or more processors 106. Optionally, program instructions 112 are performed by more than one processor. According to some embodiments, program instructions 112 may include instructions to analyze the image data (e.g. received through bus 107) to detect a change in a region of interest of the safety coupling relative to reference data. Optionally, the region of interest includes an element or a part of an element of the safety coupling. According to some embodiments, the region of interest includes at least a portion of a first perimeter of a first part and at least a portion of a second perimeter of a second part of the safety coupling, as described in greater detail elsewhere herein. In some embodiments, one or more program instructions include instructions to detect a deviation or displacement between the first and second perimeters.

According to some embodiments, the change may be detected by comparing currently obtained image data with previously obtained image data of the safety coupling, optionally by sub system 105. According to some embodiments, the change may be detected by comparing currently obtained image data with reference images of the safety coupling. According to some embodiments, the reference images may include, among others, image data of a safety coupling with various types of changes, and/or of a safety coupling devoid of a change. According to some embodiments, the reference images may be stored in a database 110.

According to some embodiments, the change may be detected by comparing currently obtained image data with previously obtained image data of different safety couplings. According to some embodiments, the change may be detected by comparing currently obtained image data with images of properly functioning safety coupling and/or with images indicating faults associated with failure modes of the safety coupling, as elaborated elsewhere herein.

According to some embodiments, the change in the currently obtained image may be compared with an image having different illumination conditions so as to eliminate changes created by illumination conditions.

According to some embodiments, the change may be detected by comparing data retrieved from the image data to non-image reference data, such as data on distance between parts of the valve, alignment between parts of the valve or between a part of the valve and surrounding data. Optionally, the non-image reference data is retrieved from previous analysis of images by processing circuitry 104 or by other processing circuitries.

According to some embodiments, program instructions 112 may include instructions to determine whether the change is a fault associated with a failure mode. According to some embodiments, determining whether the detected change is a fault associated with a failure mode may be based, at least in part, on data stored in database 110 (such as but not limited to, data related to failure modes of the safety coupling). According to some embodiments, program instructions 112 may include instructions to analyze the change in the image so as to detect a minor change in the imaged part of the valve which cannot be detected by the naked eye. For example, the program instructions may include calculation of a minor deviation between two parts of the valve, such as deviation of less than 0.5, 0.2 or 0.1 mm. It is assumed that a change on one portion of the valve will affect other portions of the valve perimeter. Therefore, program instructions used with embodiments of the invention enables the system to analyze less than the entire perimeter of the valve.

According to some embodiments, one or more algorithms 112 may include a trained neural network (NN), wherein the NN is configured to detect a change from the image data received from the at least one image sensor, determine whether the change is a fault associated with a failure mode, and output a signal indicative of the fault associated with the failure mode and/or information related thereto, to a user. Put differently, the NN may be configured to receive the image data from the at least one image sensor and output a signal indicative of the fault associated with the failure mode. According to some embodiments, the NN may include a directed NN (DNN), such as a convolutional NN (CNN). According to some embodiments, the NN may include multiple layers (i.e., a deep learning (DL) architecture) with temporal processing capabilities, such as but not limited to, recurrent NNs (RNNs), transformers, and the like. Each possibility is a separate embodiment.

According to some embodiments, program instructions 112 may include instructions to analyze a trend of the identified failure mode. According to some embodiments, program instructions 112 may include instructions to determine a probability of the fault to develop into a failure of the safety coupling. According to some embodiments, program instructions 112 may include instructions to calculate a rate of change of the fault in developing into a failure of the safety coupling. According to some embodiments, program instructions 112 may include instructions to calculate time and/or mileage and/or the number of operations (e.g. number of landings and/or takeoffs of an aircraft) to failure and/or expected failure of the safety coupling, optionally depending on the environmental data. According to some embodiments, program instructions 112 may include instructions to calculate a separation load at which the safety coupling will stop fluid supply due to the identified fault. According to some embodiments, NN algorithms may be applied to calculate a trend/rate of change of the fault associated with a failure mode into a failure.

According to some embodiments, program instructions 112 may include image processing and/or computer vision algorithms optionally for detecting a change in the captured image. According to some embodiments, program instructions 112 may include classification algorithms for classifying the faults as associated with a failure mode or not, or for classifying the severity of the fault according to a calculated trend of its associated failure mode.

According to some embodiments, program instructions 112 may include instructions to output a signal indicative of the fault associated with the failure mode and/or information related thereto, such as a trend/rate of change of the fault developing into a failure of the safety coupling. According to some embodiments, the signal may include a sound (e.g., a voice message and/or an alarm sound), a vibration, a text message, and the like, or any combination thereof, to the user. According to some embodiments, the signal may optionally include instructions configured to guide a user for taking appropriate measures. According to some embodiments, the instructions may include, among others, maintenance schedule of the safety coupling or components thereof, cleaning the safety coupling and/or sub-system 105, replacement of the safety coupling or any components thereof and/or sub-system 105, or any other instructions related to the device wherein the safety coupling is installed/coupled to. As a non-limiting example, the signal may include landing requirements of an airplane when a fault classified as a high risk is detected. As another non-limiting example, the signal may include calculated mileage, time and/or number of operations (e.g. number of landings and/or takeoffs of an aircraft) until the fault will develop into a failure of the safety coupling when a fault is classified as being at a lower risk. Optionally, the signal may include a separation load at which the safety coupling will stop fluid supply due to the identified fault.

According to some embodiments, system 100 may include one or more interfaces 114 in communication with processing circuitry 104 for inputting and/or outputting data. For example the interface may serve to input image data and/or communicate with other components in a machine and/or to communicate with external machines or systems and/or to provide a user interface.

In one example, indicators and information about the mechanism's state, health and so forth are provided via interface(s) 114 to a HUMS, CBM or similar systems.

In a second example, a failure mode indicator may be provided to an aircraft navigation system, so that the aircraft control system instructs immediate landing of the aircraft in which the safety coupling is installed.

According to some embodiments, interface 114 may include a user interface configured for receiving input from a user (e.g., operator of a machine/industrial system, such as driver, pilot, technician, and the like) or from a system such as a control system of a machine, e.g. aircraft, wherein the input is associated with any one or more of: environmental conditions, operation conditions, device conditions, safety coupling related properties, system properties, or any combination thereof. According to some embodiments, the user interface may include a screen, one or more buttons, a joystick, a mouse, a remote control, a display interface, a pointing device, a video input device and/or an audio input device, and the like, or any combination thereof. According to some embodiments, the user interface may include a software configured for transferring the input from the user to the processor.

According to some embodiments, one or more of interfaces 114 may include an interface, such as a graphical user interface (GUI) for delivering a signal indicative of the fault associated with the failure mode and/or information related thereto as further elaborated elsewhere herein. Optionally, the GUI is further configured for delivering a signal indicative that the safety coupling is in a healthy state when no fault associated with a failure mode is detected. According to some embodiments, user interface 114 may be configured for delivering the output signal to the user regarding the detected change. According to some embodiments, the output signal may include maintenance instructions, as elaborated elsewhere herein.

Optionally, the user may override an output from the user interface, where the output indicated a fault (i.e., the user has decided to ignore the detected fault and added an indication to the system, via the user interface). Optionally, the user automatically overrides some of the outputs by providing thresholds at which alerts are to be provided or not. In some embodiments, as detailed herein, such user input may be used by the ML algorithms (or training thereof) for ignoring such future similar detected faults, based on the input from the user.

According to some embodiments, user interface 114 may be configured to display the output signal to the user, as further elaborated elsewhere herein. According to some embodiments, user interface 114 may be configured to output a sound (e.g., a voice message and/or an alarm sound), a vibration, a text message, a voice message, and the like, or any combination thereof, to the user. As a non-limiting example, user interface 114 may display on a screen an output message to the user. As another non-limited example, user interface 114 may display a plot indicative of a calculated trend/rate of change of the fault into developing into a failure. According to some embodiments, the output signal may include a recommendation message configured to guide the user for taking appropriate measures. Alternatively, or additionally, in some embodiments, the signal may be delivered directly to an operator of the device in which the safety coupling is installed. As a non-limiting example, the output signal may be delivered directly to a pilot of an aircraft. According to some embodiments, the output signal may be delivered directly to a pilot in scenarios in which the output signal includes critical information, such as a trend wherein the fault is expected to rapidly develop into a failure. According to some embodiments, the trend wherein the fault is expected to rapidly develop into a failure mode may include, among others, time to failure of about two hours, about an hour, about 30 mins, less than about 30 mins, and the like. Each possibility is a separate embodiment. According to some embodiments, the trend wherein the fault is expected to rapidly develop into a failure may include, among others, mileage to failure, such as, about 1000 miles or less, about 500 miles or less, about 400 miles or less. Another example of a trend may include a number of operations of a machine in which the valve is installed, for example number of landings or takeoffs of an aircraft, e.g. 1, 2 or 3 taekoffs and landings before the fault is expected to develop into failure. Another example may include a separation load at which the safety coupling will stop fluid supply due to the identified fault. Each possibility is a separate embodiment.

According to some embodiments, system 100 may include a connection port (e.g., USB, type C, and the like) and/or wireless communication, to allow connecting and optionally data transferring to other electronic devices, such as controller and/or processing circuitry of the system wherein the breakaway is installed (e.g., processing circuitry and/or controller of an aircraft).

According to some embodiments, system 100 may include wired connection configured to be connected to a voltage source. Alternatively, or additionally, in some embodiments, system 100 may be rechargeable (e.g., batteries). In some embodiments, system 100 may have wireless connection to a remote server (Such as, a cloud based server).

According to some embodiments, an industrial system/machine (e.g., machinery, transportation system, and the like) in which the safety coupling is installed may include a plurality of the disclosed herein systems mounted on a plurality of fluid lines thereof.

According to some embodiments, each of the plurality of the disclosed herein systems may monitor failure modes of same or different types of safety couplings installed at the industrial system/machine. According to some embodiments, each of the one or more algorithms 112 of each of the plurality of the disclosed herein systems may learn/train from each of databases and each of one or more algorithms of others of the plurality of the disclosed herein systems. According to some embodiments, each of the one or more algorithms 112 of each of the plurality of the disclosed herein systems may learn/train from each of databases and each of one or more algorithms of others of the plurality of the disclosed herein systems when the plurality of the disclosed systems is devoid of a cloud platform.

According to some embodiments, there is provided herein a method of ongoing monitoring health of a safety coupling, optionally in real time. It is understood by one of ordinary skill in the art that the steps, as outlined below, may not necessarily be carried out in the indicated order. The order of at least some of the steps may be changed or be carried out simultaneously, as readily understood by one of ordinary skilled in the art. It may further be understood that at least one of the steps may be carried out separately from the procedure (e.g., the day before or once while the rest of the steps are reiterated).

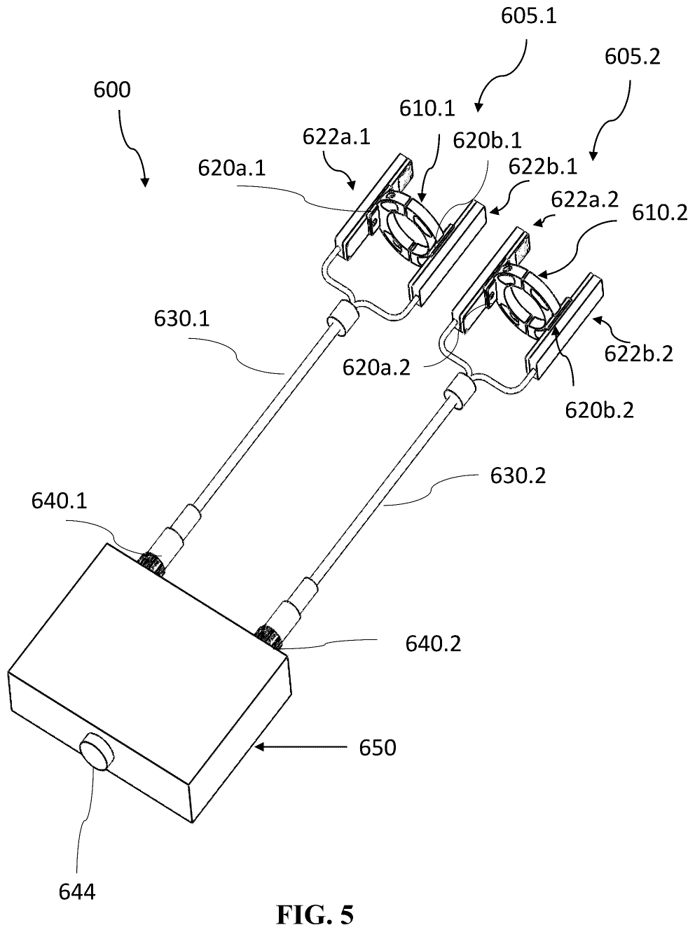

According to some embodiments, the method optionally includes positioning at least one optical sensor on or in vicinity of a safety coupling of an industrial system (e.g., an aircraft). According to some embodiments, the at least one optical sensor may be attached to an attaching means, as elaborated elsewhere herein, for example with respect to FIG. 5. According to some embodiments, the at least one optical sensor may include one optical sensor (e.g., one camera) covering less than the entire circumference of the valve at a time. According to other embodiments, the at least one optical sensor may include a plurality of optical sensors (e.g., a plurality of cameras) in order to cover a larger area of the valve circumference at a time, or all of the circumference. Optionally, when using a single optical sensor, the optical sensor is movable to cover other sections of the valve circumference and optionally monitor all of the valve circumference.

According to some embodiments, the method optionally includes capturing at least one image of a region of interest by the at least one optical sensor. According to some embodiments, the method may include capturing at least one of: an image, a set of images, a video, a set of video recordings, or any combination thereof. According to some embodiments, the method includes utilizing a processing circuitry of the disclosed system, as elaborated below, to identify a fault associated with a failure mode of the safety coupling.

According to some embodiments of the invention, the at least one image is analyzed for detecting a failure mode associated with the safety coupling.

According to some embodiments, there is provided herein a method for training a NN for analyzing an image of a safety coupling, the training includes obtaining training data for a plurality of failure modes of the safety coupling, wherein the training data includes a plurality of images of at least a portion of the safety coupling captured by at least one optical sensor, labeling the plurality of images with one or more associated failure modes and optionally also with corresponding environmental data during capturing of the image data or data from other sensors, training the NN with the plurality of labeled images. In some embodiments, the method further includes validating the training by providing to the NN a second plurality of unlabeled images of at least a portion of the safety coupling and optionally also with corresponding environmental data or data from other sensors, wherein the unlabeled images have known associated failure modes, wherein the trained NN is capable of classifying a failure mode based on an inputted image and corresponding environmental data or data from other sensors. According to some embodiments, the training data for the plurality of failure mode of the safety coupling may include a plurality of images of at least a portion of the safety coupling, wherein the plurality of images include non-failure modes thereof (i.e., depict properly functioning safety coupling).

According to some embodiments, there is provided a method for obtaining a failure mode of a safety coupling, the method including: providing at least one image captured by at least one optical sensor of at least a portion of the safety coupling and optionally also corresponding environmental data during capturing of the at least one image to the trained NN, and receiving an associated failure mode of the safety coupling.

According to some embodiments, the method may include optimizing a position of the at least one optical sensor by the NN, wherein training for optimizing the position of the at least one optical sensor may include inputting pairs of a second plurality of images and corresponding positions of the at least one optical sensor at which the second plurality of images were captured, and optionally validating the training by providing to the NN a third plurality of unlabeled images of a portion of the safety coupling and, optionally, corresponding environmental data during capturing of the at least one image or data from other sensors, wherein the third plurality of unlabeled images have known associated positions of the at least one optical sensor. According to some embodiments, the positions may include determining position coordinates (e.g., x, y, z coordinates) of the at least one optical sensor.

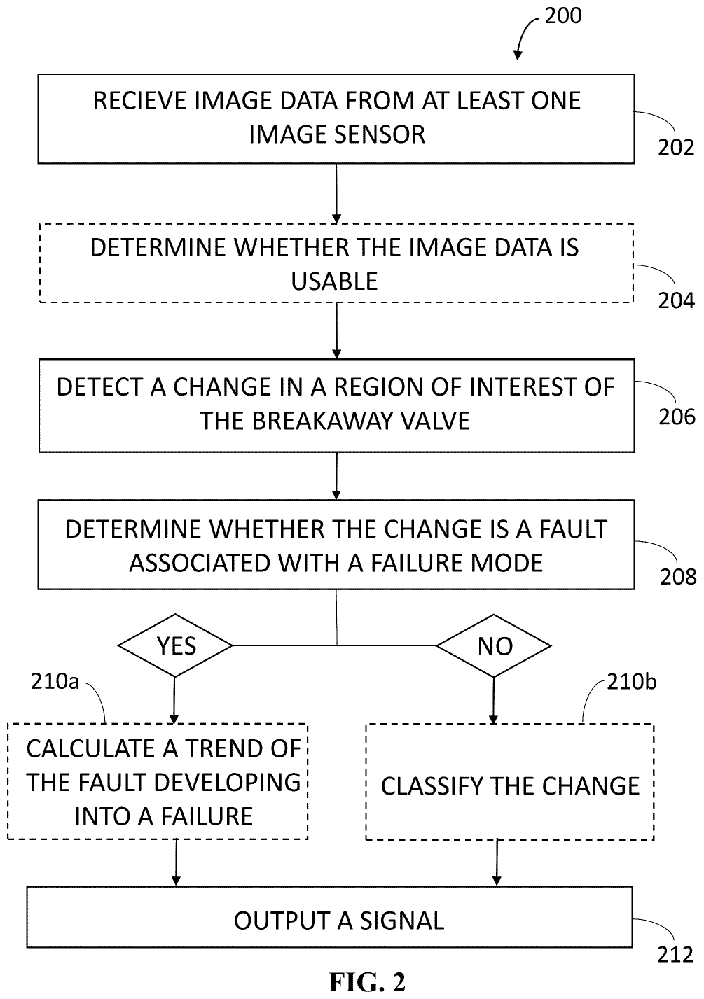

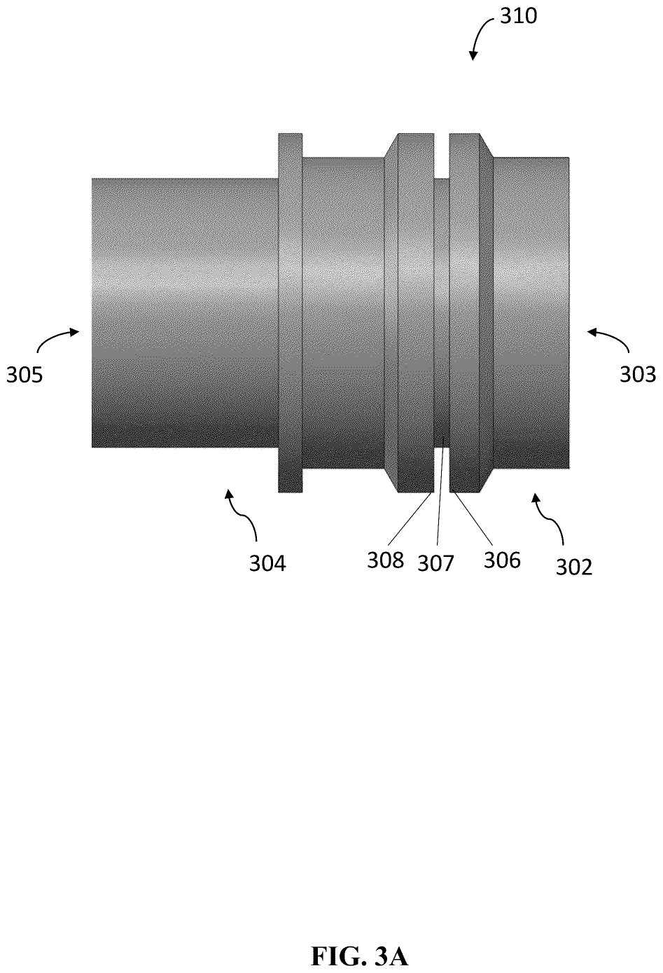

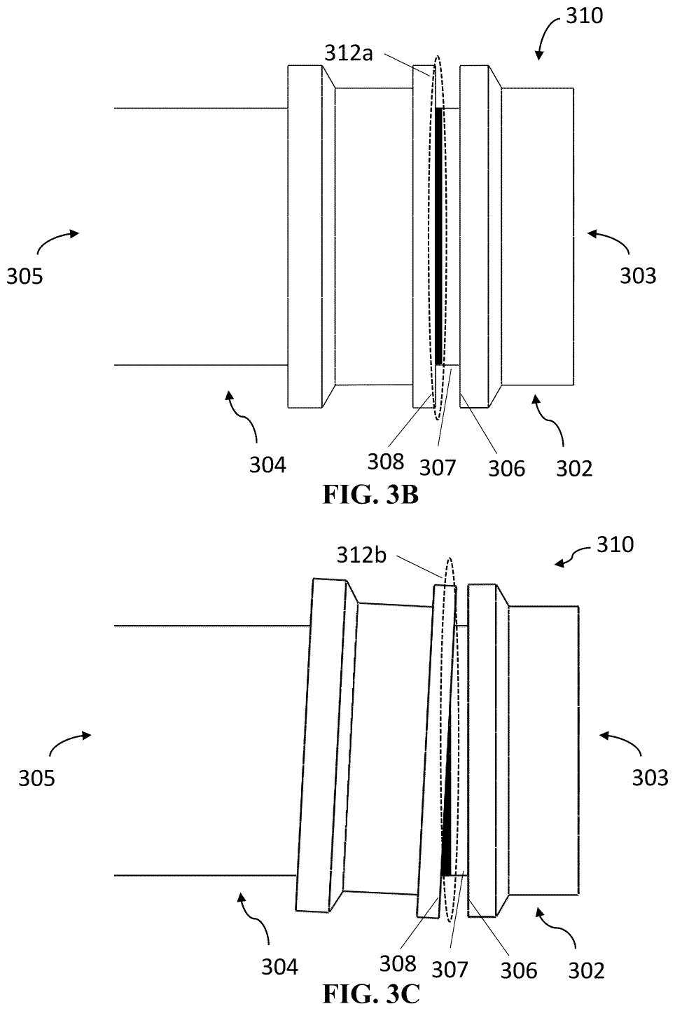

Reference is made to FIG. 2, which shows a flowchart 200 of a computer implement method for monitoring a safety coupling (such as a safety coupling 300, as depicted in FIG. 3), according to some embodiments. The method is optionally implemented by processing circuitry 104 as shown and described with respect to FIG. 1.

According to some embodiments, at step 202, the method includes receiving image data from the at least one optical sensor, for example an optical sensor from one or more sub systems 105 as shown and described with respect to FIG. 1. According to some embodiments, the image data may include or be derived from one or more of: an image, a portion of an image, a set of images, a video, a set of video recordings, or any combination thereof.

According to some embodiments, the image data may include less than an entire perimeter of the region of interest of the safety coupling. According to some embodiments, the image data may include about 10% to about 50% of the perimeter of the region of interest of the safety coupling. According to some embodiments, the image data may include about 10% of the perimeter of the region of interest of the safety coupling or less, such as between about 2-5% of the valve perimeter. According to some embodiments, the image data may include about 20% of the perimeter of the region of interest of the safety coupling. According to some embodiments, the image data may include about 20% of the perimeter of the region of interest of the safety coupling. According to some embodiments, the image data may include about 30% of the perimeter of the region of interest of the safety coupling. According to some embodiments, the image data may include about 40% of the perimeter of the region of interest of the safety coupling. According to some embodiments, the image data may include about 50% of the perimeter of the region of interest of the safety coupling. Each possibility is a separate embodiment.

According to some embodiments, the image data may be devoid of a visual failure indicator of the safety coupling provided by a manufacturer thereof. As a non-limiting example, the image data may be devoid of a color change indicative of a failure of a safety coupling. As another non-limiting example, the image data may be devoid of a texture change indicative of a failure of a safety coupling.

According to some embodiments, the image data may be preprocessed. According to some embodiments, preprocessing of the image data may include, among others, converting the image data into one or more signals (such as but not limited to electrical signals). According to some embodiments, preprocessing of the image data may include applying one or more image processing filters thereto.

According to some embodiments, at step 204, which is an optional step, the method may include determining whether the image data received from the at least one optical sensor is usable for analyzing a relative position (displacement) between a first and a second part of a safety coupling, as elaborated below. According to some embodiments, the usable image data may be substantially devoid of image saturation, reflection, light streak, flash glare, and the like or any combination thereof, in at least a portion of a region of interest of the safety coupling. According to some embodiments, the region of interest includes at least a portion of a first perimeter of a first part of the safety coupling, and at least a portion of a second perimeter of a second part of the safety coupling. According to some embodiments, the usable image data may be substantially devoid of dirt, grease, or any other fluid contaminations which conceal the region of interest of the safety coupling.

According to some embodiments, if the image data received from the at least one optical sensors is determined as unusable for detecting a change, the image data may be added to a database of the system, thereby increasing a training data set of the learning model of one or more algorithms of the system (e.g., of the neural network).

In some embodiments, when the image is determined as unusable, the method further includes providing instructions for further imaging, such as change of camera position, change of lighting or cleaning of camera lens.

According to some embodiments, at step 206, the method includes analyzing the image data to detect a change in a region of interest of the safety coupling. According to some embodiments, the region of interest may include at least a portion of a first perimeter of a first part and at least a portion of a second perimeter of a second part of the safety coupling.

According to some embodiments, analyzing the image data may include selecting a first point on the first perimeter and a second point on the second perimeter of the safety coupling, and calculating a distance between the first and the second points, to detect a change in a relative position (displacement) between the first and the second parts of the safety coupling.

In exemplary safety couplings, one of the first and second parts of the safety coupling is static and the other part is dynamic (i.e., configured to disconnect/disassemble in an emergency setting, e.g., to cease fuel supply therethrough). According to some embodiments, analyzing the image data may include taking into account mobility of the dynamic part of the safety coupling. According to some embodiments, selecting the first and the second points may take into account mobility of the dynamic part.

According to some embodiments, analyzing the image data may include re-selecting at least one of the first and the second points. According to some embodiments, re-selecting at least one of the first and the second points may be performed due to detecting dirt, grease or any other contamination or an artifact limiting the monitored portion of the region of interest of the safety coupling. According to some embodiments, re-selecting at least one of the first and the second points may be performed due to detecting saturation of at least one optical sensor, or any other lighting or reflection-related conditions affecting/limiting the quality of the obtained image data.

According to some embodiments, the change in the relative position (displacement) may include a parallel displacement between the first perimeter and the second perimeter of the safety coupling. According to some embodiments, the parallel displacement may be detected by assuming that the static part of the safety coupling is immobilized, thereby is marked as a reference for determining the displacement.

According to some embodiments, analyzing the image data to detect a change in the relative position (displacement) may include detecting an angular change (i.e., an alignment change, a non-parallel change) between the first perimeter and the second perimeter, or sections thereof, of the safety coupling. According to some embodiments, the angular change may be detected by assuming that the static part of the safety coupling is immobilized, thereby is marked as a reference for determining the angular displacement.

According to some embodiments, analyzing the image data at step 206 may include applying one or more image processing filters. According to some embodiments, the one or more filters may include noise reduction filters, configured to reduce noise and/or artifacts from the image data. According to some embodiments, the one or more filters may be applied to isolate one or more desired wavelengths from the received image data, to enhance subtle or imperceptible external changes (e.g., external changes in small areas of the image data) that cannot be determined by a human inspector. According to some embodiments, the one or more filters may be configured for identifying edges/perimeters of a first part and a second part of a safety coupling, in order to identify a change. According to some embodiments, the one or more filters may be configured for identifying edges/perimeters of the change, to facilitate detecting thereof.

According to some embodiments, analyzing the image data at step 206 may include applying a segmentation step by the one or more algorithms to analyze only a relevant part of the obtained image data. According to some embodiments. According to some embodiments, the relevant part of the obtained image data may include at least a portion of the region of interest of the safety coupling. According to some embodiments, the segmentation step may include determining/marking boundaries of a region of interest of the safety coupling.

According to some embodiments, at step 206, the method includes detecting a change in at least a portion of an element of the safety coupling.

According to some embodiments, analyzing the image data at step 206 may include comparing the image data based on one or more reference images (i.e., previously received image data). According to some embodiments, the reference image data may include image data received at “zero time” monitoring, or any other previously obtained image data (i.e., data monitored during any other monitoring time). According to some embodiments, zero time may be defined cyclically, e.g., each time a machine is turned on, every 24 hours, or any other predefined date/time.

According to some embodiments, the reference image data may include, among others, previously received image data of a same or different safety coupling (e.g., of a breakaway monitored by system 100, and/or of a different safety coupling monitored by a different system installed in a same or different device).

According to some embodiments, analyzing the image data at step 206 may include detecting the change based, at least in part, on analyzing/comparing one or more consecutively received image data, reference image data, and the like, to detect a variation/anomaly (i.e., the change) therebetween.

According to some embodiments, analyzing the image data at step 206 may include measuring a distance or alignment between two parts of the valve and comparing the measurements to reference data.

According to some embodiments, analyzing the image data at step 206 may include applying suppressors algorithms to remove identified changes not related to failure modes. For example, the suppressors may be applied to ignore changes different from the change in the relative position (displacement) between the first and the second parts of the safety coupling. According to some embodiments, the identified changes not related to failure modes may include background or foreground changes (e.g., presence of an external feature not related to the safety coupling), lighting changes, and the like, or any combination thereof.

In some embodiments, suppression may be applied by comparing the image with sequential earlier or later images such that when a change appears in only a few of a sequence of images these image(s) may be ignored and the change related to imaging parameters rather than to failure modes. For example, if a change appears in only one of a sequence of 10 images, the change may be ignored as optionally caused by glare. According to some embodiments, at step 208, the method includes determining whether the change is a fault associated with a failure mode. According to some embodiments, the fault associated with a failure mode is identifiable prior to detectability of the visual failure indicator provided by the manufacturer of the safety coupling. According to some embodiments, the fault associated with a failure mode is identifiable prior to (in terms of usage time) the detectability of the visual failure indicator at least in the imaged portion. According to some embodiments, the fault associated with a failure mode is identifiable prior to (in terms of usage mileage or separation load) the detectability of the visual failure indicator.

According to some embodiments, a fault associated with a failure mode may develop into a failure of the safety coupling. According to some embodiments, the failure mode may include, among others, structural deformation, surface deformation, a displacement between a first and a second part of the safety coupling (e.g., a change in position and/or a change in an angle between the first and the second part of the safety coupling), an alignment change (e.g., between the first and the second part of the safety coupling), a position change of the safety coupling, a crack, crack propagation, a defect, inflation, bending, wear, corrosion, leakage, a change in color, a change in appearance, repetitive movement of the first and/or the second portion of the safety coupling, and the like, or any combination thereof. According to some embodiments, the failure mode may be defined by a manufacturer of the safety coupling and/or inputted by a user. Alternatively, or additionally, in some embodiments, the failure mode may be determined using machine learning algorithms from failures in same or similar safety couplings.

According to some embodiments, one or more algorithms may be implemented to determine whether the change is a fault associated with a failure mode. According to some embodiments, the one or more algorithms may include image processing techniques. According to some embodiments, the one or more algorithms may include computer vision techniques. According to some embodiments, the one or more algorithms may include machine learning techniques. According to some embodiments, the one or more algorithms may include a neural network (NN), as elaborated elsewhere herein.

According to some embodiments, determining whether the detected change is a fault associated with a failure mode may be performed by providing to the image processing algorithm image data and data related to failure modes of safety coupling. According to some embodiments, determining whether the detected change is a fault associated with a failure mode may be performed by providing to a computer vision algorithm image data and data related to failure modes of safety coupling. According to some embodiments, determining whether the detected change is a fault associated with a failure mode may be performed by providing to a trained neural network image data and data related to failure modes of safety coupling.

According to some embodiments, determining whether the detected change is a fault associated with a failure mode may be based, at least in part, on non-image reference data. According to some embodiments, the non-image reference data may include, among others, structural properties of the safety coupling (e.g., a distance between the first and the second perimeters of the safety coupling), dimensions of the safety coupling, and the like.

According to some embodiments, the one or more algorithms may be configured to output data related to the detected change being a fault associated with a failure mode. According to some embodiments, the output data may include one or more of: an image, a portion of an image, a set of images, a video, or any combination thereof. According to some embodiments, the output data may include a calculated distance between the first perimeter of the first part and the second perimeter of the second part of the safety coupling. According to some embodiments, the output data may include a calculated distance between the selected first and second points. According to some embodiments, the output data related to the change may include identifying/marking boundaries of the change on the image data.

According to some embodiments, at step 208, the method may include classifying the change by a classifying algorithm. According to some embodiments, classifying may include classifying whether the detected change is a fault associated with a failure mode or whether the detected change is harmless (i.e., is not associated with a failure mode). According to some embodiments, classifying the change may be based, at least in part, on reference image data (e.g., previously received image data), and/or on non-image reference data. Each possibility is a separate embodiment.

According to some embodiments, if the detected change is a fault associated with a failure mode, at step 210a, the method may optionally include calculating a trend/rate of change of the fault in developing into a failure of the safety coupling.

According to some embodiments, calculating a trend/rate of change of the fault in developing into a failure may include evaluating/calculating the time duration until a failure occurs, based, at least in part, on the received data from the at least one optical sensor. According to some embodiments, the method may include calculating a trend based on the received image data over time. According to some embodiments, the trend may include a calculated time until the fault will propagate/develop into a failure. According to some embodiments, the trend may include mileage until the fault develops into a failure. According to some embodiments, the trend may include a rate of change of the fault developing into failure. According to some embodiments, the trend may refer to the separation load required for separation of the valve considering the identified fault. According to some embodiments, the trend/rate of change of the fault may be calculated by the NN algorithms.

According to some embodiments, the trend may be calculated based, at least in part, on environmental parameters. According to some embodiments, the environmental parameters (also referred to as “a set of environmental data”) may include weather conditions, temperature, humidity level, pH level, pressure, duration of operation of a machine/system (e.g., flight duration of an aircraft), velocity of movement, rate of fluid flow, and any other operation properties of the device/machine/system wherein the safety coupling is installed. As a non-limiting example, the environmental parameters may include, among others, number of flights performed by an aircraft, duration of operation (e.g., flight durations), mileage, velocity of motion, power consumption, and the like, or any combination thereof. According to some embodiments, the environmental parameters may vary over time. According to some embodiments, the trend may include calculating time and/or mileage until the fault will develop into a failure, depending on the environmental parameters. Optionally, the trend may relate to the separation load required for stopping fluid supply based on the identified fault. As a non-limiting example, the system may be configured to calculate a predicted date and time for a failure, based, at least in part on, the environmental parameters including flight schedule, flight durations/distances, and weather conditions. In some embodiments, the system may be configured to suggest a maintenance schedule in accordance with the calculated trend so as to ensure maintenance before failure occurs.

According to some embodiments, the trend may be calculated based, at least in part, on data from other types of sensors, such as vibration sensors, temperature sensors, humidity sensors and more.

According to some embodiments, at step 210a, the method may include determining a probability of the fault to develop into a failure of the safety coupling. According to some embodiments, determining the probability may be based, at least in part, on the reference data and/or on the environmental parameters and/or previously obtained image data. Each possibility is a separate embodiment. In some embodiments, the step may further include classification of the severity of fault, based on a calculated trend thereof.

According to some embodiments, if the detected change is not a fault associated with a failure mode, at step 210b, the method may optionally include classifying the harmless change. In some embodiments, if the detected change is not a fault associated with a failure mode, the method includes outputting a signal indicating that the safety coupling is in a healthy state.

According to some embodiments, the harmless change may be classified, based on a predetermined set of rules, to determine the type of the harmless change. According to some embodiments, classifying the type of the harmless change may include, among others, classifying the detected change as an image artifact, environmental change, harmless change/normal behavior of the safety coupling, and the like. According to some embodiments, the environmental change may include, among others, presence of an external feature detected on the captured image, such as dust, dirt, grease, an insect and the like. According to some embodiments, the image artifact may include, among others, image saturation, reflection, light streak, flash glare, and the like. According to some embodiments, the harmless change/normal behavior of the safety coupling may include, among others, vibration/displacement of the safety coupling due to applying load/stress thereon during normal service. According to some embodiments, load/stress applied on the safety coupling during the normal service may include, among others, operational shock, vibration/displacement of the safety coupling during landing or accelerating of an aircraft, and the like, or any combination thereof.

According to some embodiments, the system is adapted to differentiate between environmental changes on the optical sensor and environmental changes in the imaged objects. For example, the system may identify dust or droplets on the optical lens and optionally alert a user to clean the image lens or initiate automatic lens cleansing. The system may also identify dirt on the imaged object, such as a part of the valve and optionally alert the user to clean the valve or initiate automatic cleansing of the valve.

In some embodiments, the system may differentiate between dirt on the optical sensor and dirt on the valve by using any method known in the art. Optionally, the system may analyze one or more of color, blur and boundaries of a change in an area of one or more images. For example, when the area of the change does not have clear geometrical boundaries, or based upon a gray color in the image, the system may identify dirt or droplets on the optical sensor, whereas clear geometrical boundaries may indicate droplets on the valve.

According to some embodiments, the harmless change may be added to the database of the system, thereby increasing the training data set of the learning model (e.g., of the NN) of the classifying algorithm.

According to some embodiments, at step 210b, the method may optionally include classifying instructions configured to guide a user for taking appropriate measures. According to some embodiments, the instructions may include maintenance requirements (e.g., maintenance schedule, maintenance reminders, and the like) in accordance with classification of the detected fault and/or calculation of trend of failure. As a non-limiting example, the harmless change may include dirt, grease, and the like, on the safety coupling and/or on a component of the system (e.g., dirt on the at least one optical sensor, on one or more light sources), and the instructions may include instructing the user to perform cleaning of a corresponding component of the safety coupling and/or the disclosed system.

According to some embodiments, at step 212, the method includes outputting a signal to a user. According to some embodiments, the signal may include any type of signal/notification, such as a warning sound, vibration, a text message, a voice message, or any combination thereof. According to some embodiments, the signal may be indicative of the fault associated with the failure mode, the calculated trend and/or information related thereto or of a healthy state of the valve. According to some embodiments, the signal may be indicative of a harmless change and/or information related thereto.

According to some embodiments, the signal may include instructions configured to guide a user for taking appropriate measures. According to some embodiments, the instructions may include, among others, maintenance requirements (e.g., required cleaning of the safety coupling and/or of the system), replacement (e.g., of the safety coupling, of one or more light sources, optical sensors of the disclosed system, and the like), operational instructions (e.g., landing the aircraft), and the like, or any combination thereof.

According to some embodiments, the signal may include a trend/rate of change of the fault (in terms of time, mileage, separation load and the like), and/or a probability of the fault to develop into a failure of the safety coupling. According to some embodiment, the signal may be displayed or otherwise delivered to a control/operation system of the device (e.g., an aircraft). Alternatively, or additionally, in some embodiments, the signal may be delivered directly to an operator of the device. As a non-limiting example, the output signal may be delivered directly to a pilot of an aircraft. According to some embodiments, the output signal may be delivered directly to a pilot in scenarios in which the output signal includes critical information, such as a trend wherein the fault is expected to rapidly develop into a failure mode. According to some embodiments, the trend wherein the fault is expected to rapidly develop into a failure mode may include, among others, time to failure of about two hours, about an hour, about 30 mins, less than about 30 mins, and the like. Each possibility is a separate embodiment. According to some embodiments, the trend wherein the fault is expected to rapidly develop into a failure may include, among others, mileage to failure, such as, about 1000 miles or less, about 500 miles or less, about 400 miles or less. Each possibility is a separate embodiment.

Reference is made to FIG. 3A, which shows a schematic illustration of a side view of an exemplary safety coupling 310 monitored by a system according to some embodiments.

Safety coupling 310 may be installed in inaccessible areas for maintenance and/or for inspection, high-radiation and/or excessive heat areas, and the like, or any combination thereof. The inaccessible areas may include, among others, narrow areas, deep areas, areas with a limited amount of light, greasy areas, and/or areas which may be potentially damaged due to the presence of a human inspector.

The monitored safety coupling 310 may be made of or include one or more assembled/interconnected parts. For example, as depicted in FIG. 3A, safety coupling includes a first part 302 assembled to a second part 304 and an intermediate section 307 therebetween. One of first part 302 or second part 304 may be static, while the other part of first part 302 or second part 304 may be dynamic. Put differently, one of first part 302 or second part 304 may be configured to disassemble/disconnect to cease fluid supply through safety coupling 310 during an emergency.

According to some embodiments, intermediate section 307 is defined between a first perimeter 306 of first part 302 and a second perimeter 308 of second part 304. According to some embodiments, intermediate section 307 may include an interface/connection area between first part 302 and second part 304 of safety coupling 310.

Safety coupling 310 may be operatively coupled to a liquid, e.g. fuel, supply tank (not shown) via a first opening 303 of first part 302 and a second opening 305 of second part 305. Safety coupling 310 may be employed in various machines or systems in a wide variety of fields, such as, but not limited to, air, land and sea transport systems, machinery, gas supply systems, turbines, and any other systems in which safety couplings may be employed. Safety coupling 310 may be operatively coupled to a fuel line, tank-to-fuel line connections, tank-to-tank interconnections, or any other areas along a fuel system. The size and the structure of intermediate section 307 may indicate the operative status of safety coupling 310. In particular, during routine performance, first perimeter 306 (or a section thereof), second perimeter 308 (or a section thereof) and intermediate region 307 maintain a substantially constant position and angle therebetween, such that essentially no relative displacement is formed therein. Hence, allowing continuous fluid flow therethrough during routine operation (e.g., during flight), and allowing ceasing fluid supply only when required (e.g., a crash, a collision, and the like).

According to some embodiments, the disclosed system (e.g. system 100) is configured to monitor the parts, regions, portions, perimeter and/or sections of a safety coupling (such as those disclosed in FIGS. 3A-C), as further detailed herein below.

According to some embodiments, a plurality of disclosed systems (e.g., sub systems 105.1-105.n) may be operatively coupled to monitor health of a plurality of safety couplings 310 installed in one industrial machine. According to some embodiments, at least one optical sensor may be positioned in vicinity to an exemplary safety coupling 310, as elaborated elsewhere herein.

According to some embodiments, system 100 is configured to monitor safety couplings in an industrial system/machine, such as an aircraft, which may include a plurality of disclosed sub-systems (e.g., a plurality of sub systems 105) installed to monitor health of a plurality of safety couplings 310. According to some embodiments, each of the plurality of sub-systems 105 may independently image each of the plurality of safety couplings 310. Alternatively, a single sub-system 105 may be installed to image and monitor more than one safety coupling in its field of view, for example, 2, 3 or more safety couplings.

According to some embodiments, each of the plurality of sub systems may be separate/independent systems which are not connected to each other and include a separate processing circuitry 104 to perform independent analysis and monitoring. According to some embodiments, each of the plurality of systems 100 may include a shared database, to enhance learning of one or more algorithms of each of the plurality of systems 100. According to some embodiments, each database of each of the plurality of systems 100 may communicate with each other to increase databases used for analysis of the images by others of the plurality of systems, thereby optionally also facilitating training each of the one or more algorithms.

Reference is now made to FIG. 3B, which shows a schematic illustration of an image taken by an optical sensor according to some embodiments of the invention showing a side view of the safety coupling 310 of FIG. 3A in a first configuration formed by a parallel displacement between first perimeter 306 of first part 302 and second perimeter 308 second part 304 of safety coupling 310, according to some embodiments. In this first configuration, the image shows a first portion of the visual failure indicator 312a in intermediate section 307.

Reference is now made to FIG. 3C, which shows a schematic illustration of an image taken by an optical sensor according to some embodiments of the invention showing a side view of the safety coupling 310 of FIG. 3A in a second configuration formed by a non-parallel displacement (i.e., angular change) between first perimeter 306 of first part 302 and second perimeter 308 second part 304 of safety coupling 310. In this second configuration, the image shows a second portion visual failure indicator 312b intermediate section 307.

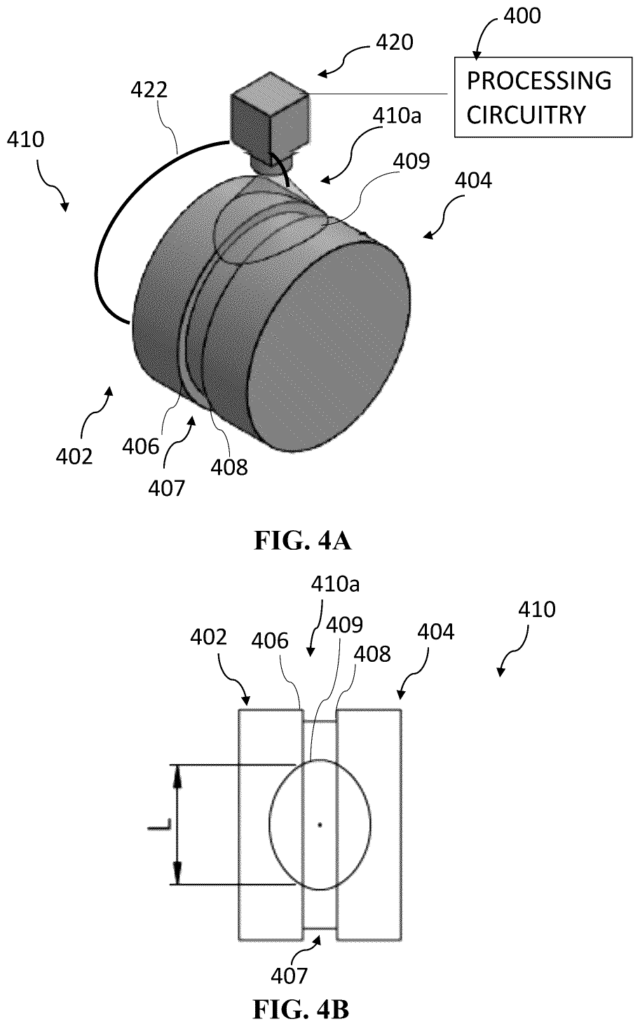

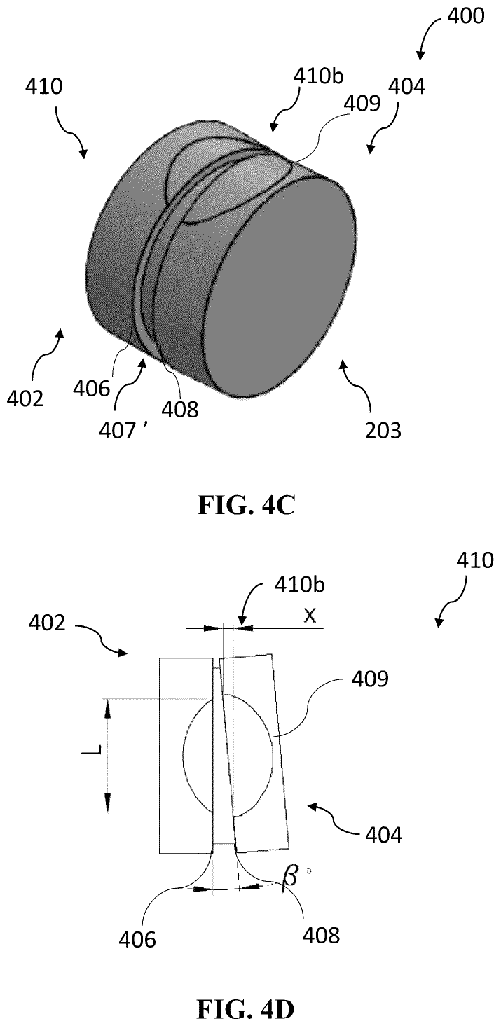

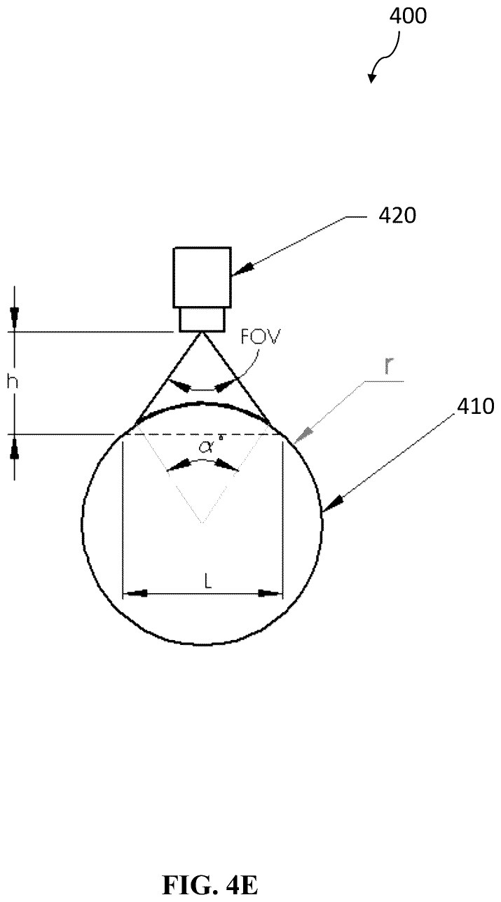

Reference is made to FIG. 4A, which shows a schematic illustration of a perspective side view of a system 400 for monitoring a region of interest 409 of a safety coupling 410 and to FIG. 4B, which shows a projection of region of interest 409, as taken by an optical sensor according to some embodiments. System 400 optionally receives image data from a sub system 420 including an optical sensor and optional illumination source as described with respect to sub systems 105 above. System 400 includes a processing circuitry with one or more processors similar to processing circuitry 104 shown and discussed with respect to FIG. 1 above.

As depicted in FIG. 4A, monitored safety coupling 410 is in a first configuration 410a formed by a parallel displacement between a first perimeter 406 of a first part 402 and a second perimeter 408 of a second part 404 of safety coupling 410. In first configuration 410a, a change in a relative position (displacement) in a region of interest 409 of safety coupling 410 is a parallel displacement between first perimeter 406 and second perimeter 408.

According to some embodiments, system 400 is configured to detect a parallel displacement between first perimeter 406 of first part 402 and second perimeter 408 of second part 404 of safety coupling 410.

According to some embodiments, the system detects a parallel displacement of first perimeter 406 and/or the second perimeter 408 by detecting an increase in the distance therebetween within the image data (i.e., increase in the width of an intermediate section 407). According to some embodiments, the processor(s) may detect a parallel displacement of first perimeter 406 and/or the second perimeter 408 by detecting a decrease in the distance therebetween (i.e., decrease in the width of an intermediate section 407) within the image data.

The parallel displacement may include a deflection of first and/or second parts 402 and 404 of safety coupling 410. According to some embodiments, the processor(s) detect a parallel displacement (i.e., first perimeter 404 and/or second perimeter 404 are axially displaced while being parallel), by detecting a change in position of more than one point along first perimeter 404 and/or second perimeter 406 by the same magnitude within the image. Hence, in some embodiments, the processing circuitry includes program instructions to select a first point on first perimeter 406 and a second point on second perimeter 408 within the region of interest, and calculate a distance therebetween, thereby detecting a change present at any point along the entire perimeter. As the displacement is parallel the displacement can be detected at any point along the circumference of the valve. Hence, in such a case, a system including one sub system (e.g., with one optical sensor 420) may suffice for detection of the parallel displacement.

According to some embodiments, analyzing the image data may include taking into account mobility of a dynamic part of the safety coupling where the safety coupling is configured of interconnected static and dynamic parts, for example by using the static part as a baseline for analyzing deviation of the dynamic part and selecting the first and second points accordingly. In some embodiments, the processor(s) may monitor only the dynamic part and may use a different baseline for detecting deviation of the dynamic part, for example another static object in the image or a line drawn on the image taking into account that the optical sensor is stationary with respect to the valve.

According to some embodiments, after a first analysis of the image data (as detailed above), the processor(s) may re-select at least one of the first and the second points. According to some embodiments, re-selecting at least one of the first and the second points may be performed due to detecting dirt, grease or any other contamination or an artifact limiting the monitored portion of the region of interest of the safety coupling. According to some embodiments, re-selecting at least one of the first and the second points may be performed due to detecting saturation of at least one optical sensor, or any other lighting or reflection-related conditions affecting/limiting the quality of the obtained image data.

According to some embodiments, selecting the first and the second points and calculating the distance therebetween, allows detecting the change in the relative position (displacement) optionally without comparison to other image data. According to some embodiments, detecting the change in the relative position (displacement) may include detecting the parallel displacement between the first perimeter and the second perimeter of the safety coupling. According to some embodiments, detecting the change in the relative position (displacement) may include detecting a non-parallel displacement (i.e., angular change, as further elaborated herein) between the first perimeter and the second perimeter of the safety coupling. According to some embodiments, the displacement type may be detected by assuming that the static part of the safety coupling is immobilized, thereby is marked as a reference for determining the displacement.

According to some embodiments, and as depicted in FIGS. 4A, system 400 includes sub system 420. According to some embodiments, and as depicted in FIG. 4A, sub system 420 may include one optical sensor (e.g., one camera). Optionally, the optical sensor is positioned static to the safety coupling. Alternatively, the optical sensor may move with respect to the valve to image different portions of the valve circumference. Alternatively, in some embodiments, optical sensor 420 may include a plurality of optical sensors (e.g., a plurality of cameras), such as 2, 3, 4 or 5 optical sensors, positioned at different locations relative to safety coupling 410. Alternatively, system 400 may receive image data from two or more sub systems 420 imaging the safety coupling from different directions. Each possibility is a separate embodiment.

According to some embodiments, increasing the number of optical sensors may lead to an enlarged captured region of interest 409 (e.g., allowing monitoring a larger portion along a perimeter of safety coupling 410), thereby monitoring otherwise non-imaged portions of first and/or second perimeters 406 and 408. However, in some embodiments, increasing the number of optical sensors may increase the number of sub systems 420, which, in turn, increases the occupied space by sub systems 420 and/or increase the computer resources required for transmission and analysis of the images. Also, the space available around safety coupling 410 may be limited by other components of a machine/industrial system in which safety coupling 410 is installed.

According to some embodiments, decreasing the number of the optical sensors may increase the available space around safety coupling 410, allowing installing other systems/components nearby, and increasing the accessibility to safety coupling 410. The inventors of the present application have found that increasing the sensitivity of the camera sensor and/or analysis may enable the use of a single sensor for monitoring health of a safety coupling. The inventors have found that a change on one portion of the valve circumference will affect the entire circumference of the valve and using a high definition camera and/or analysis of the image data may detect a change in any portion of the valve circumference imaged.

According to some embodiments, attaching means 422 may be provided configured fix the position of sub system 400 relative to intermediate region 407. According to some embodiments, attaching means 422 may be configured to also position one or more light sources (as shown with respect to sub system 105 in FIG. 1) in vicinity of safety coupling 410. Optionally, in some embodiments, attaching means 422 may be configured to position a processing circuitry (not shown) in vicinity of safety coupling 410. Alternatively, in some embodiments, the processing circuitry may be positioned away from safety coupling 410 (e.g., in a control room, and the like). Exemplary attachment means of the sub system are illustrated in FIG. 5 below.

According to some embodiments, attaching means 422 may be configured to retain sub system(s) 420 at a constant position (e.g., essentially constant distance from each other and/or from safety coupling 410) which may case comparison between two or more images taken by the optical sensor(s). According to some embodiments, attaching means 422 may be configured to fix detachably or permanently sub system 420 to safety coupling 410. According to some embodiments, detachably attached sub system 420 may be replaceable, for example when broken.

According to some embodiments, attaching means 422 may include any means which maintain the sub system in a controlled position with respect to the valve, such as a strap, a harness, a frame, a detachable connector, a locking mechanism, a clamped-lid mechanism, mechanical latches or snaps, crimped sleeves, and the like.

According to some embodiments, system 400 and/or sub system 420 may be washable (e.g., by liquids, air flow, and the like. According to some embodiments, system 400 may include or be in communication with a cleaning system, configured to clean safety coupling 410 and/or sub system 420. According to some embodiments, sub system 420 may be water resistant. According to some embodiments, sub system 420 may be airflow resistant. According to some embodiments, system 400 and/or sub system 420 may be compatible with any conditions or restrictions necessary for safe operation of an aircraft, vehicle or train. As a non-limiting example, sub system 420 may be mechanical vibration and/or shock resistant.

According to some embodiments, region of interest 409 includes at least about 10%, about 20%, about 30%, about 40%, about 50% or more of a first perimeter 406 of a first part 402 of safety coupling 410 and/or at least about 10%, about 20%, about 30%, about 40%, about 50% or more of a second perimeter 408 of a second part 404 of safety coupling 410, and/or at least about 10%, about 20%, about 30%, about 40%, about 50% or more of an intermediate area 407 between first and second parts 402 and 404 of safety coupling 410. According to some embodiments region of interest may captured in the image data may include about 10% to about 50% of the entire perimeter of first perimeter 406 and/or of second perimeter 408. When more than one optical sensor is used, region of interest may include 60% or more of the perimeters of the parts of the coupling. Optionally, the entire coupling perimeter is monitored. Each possibility is a separate embodiment.

Put differently, in some embodiments, region of interest 409 includes at least about 10°, 30°, 50°, 70°, 90°, 110°, 130°, 150°, or 180° of the circumference of the valve. A detailed explanation with respect to the desired size of the region of interest as a function of the position and resolution of the valve is provided with respect to FIGS. 4D and 4E below.

According to some embodiments, and as marked in FIG. 4B, a length L indicates a length of detection of region of interest 409. According to some embodiments, the length L may include about 10%, about 20%, about 30%, about 40%, about 50%, about 60%, about 70% or more of the perimeter (e.g., circumference) of the intermediate region 407. Put differently, the non-imaged portion of the intermediate region 407 may include about 90%, about 80%, about 70%, about 60%, about 50%, about 40%, about 30%, about 20% or less of the perimeter of intermediate region 407.

Reference is now made to FIG. 4C which shows a schematic illustration of a perspective side view of safety coupling 410 monitored by system 400, and to FIG. 4D, which shows a projection of region of interest 409, according to some embodiments.

According to some embodiments, and as depicted in FIG. 4C, safety coupling 410 is in a second configuration 410b formed by a non-parallel displacement (i.e., an angular change) between first perimeter 406 of first part 402 and second perimeter 408 of second part 404 of safety coupling 410. According to some embodiments, in second configuration 410b, a change in a relative position (displacement) in a region of interest 409 of safety coupling 410 is the non-parallel displacement between first perimeter 406 and second perimeter 408.

According to some embodiments, system 400 is configured to detect the non-parallel displacement (i.e., the angular change) between first perimeter 406 of first part 402 and second perimeter 408 of second part 404 of safety coupling 410.

According to some embodiments, and as depicted in FIG. 4C and FIG. 4B, in contrast to the parallel displacement, wherein the detected displacement is uniform at each point across the region of interest 409, in the detected non-parallel displacement of FIG. 4C the system detects a different displacement between any point of first perimeter 406 and second perimeter 408.

According to some embodiments, the non-parallel displacement may be detected by monitoring a change in an angle between first perimeter 406 and second perimeter 408 or in sections thereof (i.e., by monitoring region of interest 409) and/or by monitoring a change in position between first perimeter 406 and second perimeter 408 of first part 402 and of second part 404 of safety coupling 410. According to some embodiments, and as depicted in FIG. 4D, an angle β is a tilt angle (i.e., indicating an angle change) between first perimeter 406 (or a section thereof) and second perimeter 408 (or a section thereof) formed due to a non-parallel displacement of first perimeter 406 and/or second perimeter 408 or sections thereof. According to some embodiments, and as depicted in FIG. 4D, the angle b is an acute angle. According to some embodiments, the angle b may include any value, such as any value of an acute angle, obtuse angle, and/or a straight angle. It may be understood by skilled in the art that in a scenario in which the angle β is detected as equal to zero, the system would determine that no tilt (i.e., no angular misalignment) is formed between first perimeter 406 and second perimeter 408.

Non-parallel displacement includes displacement of first perimeter 406 and/or second perimeter 408 including a change in tilt angle β therebetween. Non parallel displacement may be for example due to one or more of crack, structural deformation, wear, and the like. Hence, in some embodiments, the system detects a change in the position along various points on first perimeter 404 and/or second perimeter 406 to be different (e.g., as depicted in FIG. 4C). According to some embodiments, the detection of the non-parallel displacement, and in particular in a scenario wherein the tilt angle β is formed 90° degrees relative to the position of sub system 420, requires attentively defining parameters such as the minimum length of L, the minimum length of x, the position and the properties of sub system 420.

The correlation between the distance of the cameras from the safety coupling, the camera's field of view (FOV), and the sizes of the region of interest 409 is described with respect to FIG. 4E in which:
h—the distance of the optical sensor from the monitored area of the breakaway valve.
FOV—The diagonal Field Of View of the optical sensor
L—The length of the region of interest captured in a frame, can be calculated by:

$$L = 2 * h * tg ( \frac{FOV}{2} )$$

r—The radius of the safety coupling.
∝—The angle of the monitored section in the valve, which can be calculated by:

$$∝ = 180 - 2 * {cos}^{- 1} ( \frac{L}{2 * r} )$$

When a parallel displacement occurs, e.g., the two parts of the safety coupling move in a parallel axial movement, that is, the two sides of the slot move closer or further away from each other while maintaining parallelism, a single optical sensor may suffice as the change in the distance between the parts is the same everywhere on the coupling's circumference.

However, a non-parallel displacement will cause an angle between the parts and as a result, the displacement is different along the circumference of the valve.

The most difficult displacement to monitor is when the angle of the displacement is exactly 90 degrees to the direction of the camera, as shown in FIGS. 4C and 4D for example illustrating a round image area (it can also be square) and a cylindrical safety coupling. It should be appreciated that embodiments of the invention also cover an image area having square or oval shape and the different shapes of the valve circumference.

For a cylindrical shape valve, the distance between the camera and the monitored area varies on the coupling's circumference, therefore the projection of the monitored area has an elliptical shape and L is the length of the slot's side circumscribed by the ellipse, as shown in FIG. 4D.
β—The angle between the two parts of the coupling i.e., the angular displacement of the parts.
X—In simplification, the maximum linear displacement resulting from angle β within the monitored area.

$$x = L * sin β$$

Considering all the formulas above, when defining the minimum number of pixels that the monitored defect should cover with the optical sensor, it is possible to calculate the size/minimum displacement angle that can be detected with one optical sensor, the location of the optical sensors, and the number of optical sensors needed to monitor the valve.

For example, for an optical sensor with an FOV of 50° positioned at a distance of 60 mm from a safety coupling having a radius of 100 mm:

$$L = 2 * 60 * tg ( \frac{50}{2} ) = 55.95$$

$$∝ = 180 - 2 * {cos}^{- 1} ( \frac{55.95}{2 * 100} ) = {32.5}^{0}$$

As an example, it is desired to locate deviation of 0.1° between the two parts:

$$x = 55.95 * sin 0.1 = 0.097$$

Thus, in this example, the optical sensor should be one with a resolution that can locate a movement of 0.1 mm. The following calculation can be performed in order to provide an optical sensor with a suitable resolution.

The number of pixels covering the object (The monitored defect/displacement) refers to the amount of the image sensor that is occupied by the object. It depends on the size of the object, its distance from the camera, and the camera's FOV and resolution.

The distance between the camera and the object determines the size of the object within the image. As the distance decreases, the object appears larger in the captured frame, resulting in more pixels covering the object. Conversely, as the distance increases, the object appears smaller, and fewer pixels cover the object.

According to some embodiments, calculation of number of pixels required for covering the object in terms of the size of the object, its distance from the optical sensor, and the sensor's FOV and resolution, is performed using the following formula:
N—Number of pixels in the sensor image area, for simplification of this example, we use the number of pixels in the length of the sensor.
W—Number of pixels in the sensor width.
X—Object Size: The physical size of the monitored object
h—The distance of the camera from the monitored area.

$$N = \frac{X}{h} * \frac{W}{2 * tg ( \frac{FOV}{2} )}$$

As an example:
Camera resolution—1280×1280
FOV 50°
The distance of the camera from the safety coupling: h=100 mm
Displacement size (object size): X=0.1 mm (for simplification of this example, we use the Length of the displacement instead of its area)

$$N = \frac{0.1}{100} * \frac{1280}{2 * tg ( \frac{50}{2} )} = 1.37$$

Using the correlation and formulas above, the present invention may enable the use of optical sensors with low resolution to provide a sensitive analysis of deviation in a safety coupling.

For example: for the case described above, given the number of pixels that cover the displacement to be at least 5:

$$W = N * \frac{h}{X} * 2 * tg ( \frac{FOV}{2} )$$

$$W = 5 * \frac{100}{0.1} * 2 * tg ( 25 ) = 2 , 331$$

The resolution of the optical sensor should be 2,331×2,331 and there is no need to use a higher resolution sensor.

According to some embodiments, using the same calculations, for a given displacement and a given sensor's resolution, a sensor distance and FOV can be chosen, thereby optionally enabling the use of a single optical sensor for monitoring one or more safety coupling.

The same calculations can be used if the use of 2 cameras or more is needed.

According to some embodiments, the following calculation is used in order to calculate the required FOV given the resolution of the optical sensor:
px.size—represents the size of the pixel in the optical sensor
N.pixel—represents number of pixels required to distinguish the smallest deviation
Px.density—represents the density of the pixels

Calculation of angle deviation:

$$β = ( x / h ) * ( 180 / π )$$

Calculation of pixel density:

$$Px \cdot density = 1 / ( tan ( FOV / 2 ) * px \cdot size$$

Number of pixels required to image a minimum deviation:

$$Number of Pixels = ( β / ( 1 / px \cdot density ) ) = Number of Pixels = ( x / h ) * ( 180 / π ) * ( 1 / ( tan ( FOV / 2 ) * px \cdot size ) )$$

In case where x is smaller than number of pixels the optical sensor will not detect the deviation accurately.

For example:
h=10 mm
x=20 microns
px.size=3 microns
FOV1=30 degrees
FOV2=140 degrees

$$Number of pixels ( FOV 1 ) = ( 20 microns * ( 180 / π ) ) / ( 10 mm * tan ( 30 degrees / 2 ) * 3 microns ) \approx 3.055 pixels$$

$$Number of pixels ( FOV 2 ) = ( 20 microns * ( 180 / π ) ) \text{} / ( 10 mm * tan ( 140 degrees / 2 ) * 3 microns ) \approx 0.319 pixels$$

In case of FOV2, where the FOV is 140 degrees, less than 1 pixel is provided to represent the deviation, which is insufficient. Thus, this equation can assist in determining the required FOV of the optical sensor.

According to some embodiments, and as depicted in FIG. 4D, the non-parallel displacement may be detected by monitoring a change in position of first perimeter 406 and of second perimeter 408 or sections thereof (i.e., by monitoring region of interest 409) for example by monitoring a distance change between first perimeter 406 and second perimeter 408 of first part 402 and of second part 404 of safety coupling 410. According to some embodiments, and as depicted in FIG. 4D, the non-parallel displacement may be detected by detecting a length x, wherein length x indicates a length of a linear displacement between an initial/proper position and currently captured position of each of first perimeter 406 and second perimeter 408. According to some embodiments, length x indicates the length of the position change across the detection length L.

According to some embodiments, the non-parallel displacement may be detected by monitoring length x and/or tilt angle b.

According to some embodiments, tilt angle b may indicate rotational movement of first perimeter 406 (or a section thereof) and/or of second perimeter 408 (or a section thereof). According to some embodiments, tilt angle b may indicate bending of first perimeter 406 (or a section thereof) and/or of second perimeter 408 (or a section thereof).

According to some embodiments, the non-parallel displacement may be detected by selecting at least two points (e.g., at least one point on first perimeter 406 and at least one point on second perimeter 408, and calculating a distance therebetween, as elaborated elsewhere herein. According to some embodiments, the non-parallel displacement may be determined by taking into account that the static part (i.e., the first or the second part 402 or 404 of safety coupling 410) is immobilized, thereby serving as a reference in determining the non-parallel displacement.

The detected non-parallel displacement may include a combination of an angle change and a position change in region of interest 409. The combination of the position change and the angle change may include parallel displacement between first perimeter 406 and second perimeter 408 and bending of at least a section of first perimeter 406 and/or at least a section of second perimeter 408. It may be understood by one skilled in the art that the position change and/or the angle change of each of first and second perimeters 406 and 408 may include various displacement sizes, types, directions, structure change/deformation, and the like.

According to some embodiments, decrease in the detection length L of region of interest 409 leads to decrease in the length x, for a given size of the angle b. According to some embodiments, decrease in the size of the angle b leads to decrease in the length of x, for a given detection length L. Thus, the system may determine severity of the change by measuring length x and angle b.

According to some embodiments, system 400 may be configured to monitor a position change (i.e., the length x) of at about 0.5 mm, 0.4 mm, 0.3 mm, 0.2 mm, 0.1 mm or less between first perimeter 406 (or a section thereof) of first part 402 and second perimeter 408 (or a section thereof) of second part 404 of safety coupling 410. According to some embodiments, system 400 is configured to monitor a position change (i.e., the length x) of at least about 0.1-0.8 mm. Each possibility is a separate embodiment.

According to some embodiments, system 400 is configured to monitor an angle change (i.e., the size of tilt angle b) of about 5°, 4°, 3° or less between first perimeter 406 (or a section thereof) of first part 402 and second perimeter 408 (or a section thereof) of second part 404 of safety coupling 410 for example using the distance and/or position change calculation defined above. According to some embodiments, system 400 is configured to monitor an angle change (i.e., the size of tilt angle b) of at about 2-6°. Each possibility is a separate embodiment.

According to some embodiments, system 400 is configured to detect a change having an area (e.g., a color change area, a texture change area, and the like) of about 0.5 cm² or less. According to some embodiments, system 400 is configured to detect a change having an area (e.g., a color change area, a texture change area, and the like) of about at about 0.4 cm² or less. Each possibility is a separate embodiment.

According to some embodiments, identifying the change may include analyzing the one or more captured imaged and/or signals therefrom (i.e., analyzing raw data received from the at least one optical sensor). According to some embodiments, system 400 may include analyzing the area, tilt angle b and/or length x to identify the presence and/or severity of the change. According to some embodiments, identifying the change may include detecting a change of the tilt angle b and/or length x by an algorithm configured to compare two or more images (or signals thereof). According to some embodiments, comparing the two or more images may include comparing a captured image and a reference image (e.g., previously captured image, known images with faults, and the like). According to some embodiments, the comparison performed by the algorithm may show that the two or more images are essentially the same, thereby labeling/classifying the change as not detected (i.e., no change). According to some embodiments, the comparison performed by the algorithm may show that the two or more images are different (e.g., due to identified change in the size of the tilt angle b and/or length x), thereby labeling/classifying the change as a detected change (e.g., a parallel displacement). According to some embodiments, the algorithm may include a predefined threshold for the identified number of different pixels/signals for determining that the two or more images are different.

According to some embodiments, system 400 may include analysing the change as a fault associated with a failure mode. system 400 may store in its memory a list of one or more failure modes, such as for example, displacement, deviation, cracks, etc. optionally, each failure mode includes parameters of the failure mode, such as change in distance, angle, colour, etc. Upon detection of a change the processing circuitry may analyse whether the parameters of the detected change qualify with the parameters of any of the stored failure modes and determine a fault associated with a failure mode upon such finding or determine health of the valve when no match is found.

When a fault is detected to be association with a failure mode, system 400 may classify that the change will develop into a failure. According to some embodiments, classifying may include comparing the parameters of the change with parameters stored in the database of system 400 and determining severity of the fault. For example, a fault may be classified as high requiring immediate stop of the machine, medium enabling short operation of the machine or operation under specific parameters or low enabling normal operation for a specified period of time before maintenance is required.

According to some embodiments, if the detected change is harmless (e.g., normal behaviour of breakaway), data related to the change (e.g., signals, images, portions of images, and the like) may be stored in the system database, updating the database and training the one or more algorithms to ignore the detected change in the future, thereby facilitating future fault identifications, and saving operational time of the one or more algorithms. According to some embodiments, if the detected change is determined to indicate healthy operation of the valve it may indicate other parameters which cause the change to be detected in monitoring system 400. In such circumstance, the system may optionally output a signal including instructions configured to guide a user for taking appropriate measures, such as cleaning of the safety coupling or of sub system 420. According to some embodiments, if the change is harmless, or no change is detected, the system may optionally output a signal indicative of proper service of the safety coupling.

According to some embodiments, if the change is a fault associated with a failure mode, the one or more algorithms may include calculating a trend predicting the process until the failure mode will develop into a failure (e.g., calculating propagation of the fault). According to some embodiments, the trend may be calculated by comparing a plurality of consecutive images taken by the optical sensor to identify rate of change/propagation of the fault, as elaborated elsewhere herein. Alternatively, the trend may be calculated by comparing to images stored in the database of a different valve showing a similar fault and the trend thereof. Or, the trend may be calculated by comparing parameters of the detected fault to similar parameters in the system showing a similar fault and trend thereof. Optionally, such comparison also takes into account environmental data of the monitored valve and environmental data stored in the system.

Reference is made to FIG. 5, which schematically illustrates a system 600 for monitoring health of safety couplings, according to some embodiments. System 600 may be similar to any of systems 100, 400 and/or 500 described above.

FIG. 5 illustrates the system with two sub-systems (605.1 and 605.2) for monitoring two safety couplings. It is to be understood that any number of sub-systems may be provided according to embodiments of the invention, including a single sub-system or more than two sub-systems, such as three, four, eight, ten, twenty or more. In addition, FIG. 5 illustrates each sub-system with two optical sensors. It is understood that any number of optical sensors may be provided to each sub-system as desired, including a single optical sensor. It is further understood that sub-systems with different number of optical sensors may be provided within the same system.

According to some embodiments, a system 600 may be installed in an industrial machine or vehicle, for example an aircraft, such as an airplane, helicopter, UAV, space vehicle and others for monitoring a plurality of safety couplings within the same machine or vehicle.

According to some embodiments, each sub-system 605 includes one or more brackets 610 (610.1 and 610.2) each configured to be positioned/attached to a safety coupling. Optionally, the bracket may surround the region of interest of the valve. According to some embodiments, a perimeter/circumference of bracket 610 may be adjustable, thereby fitting a wide variety of safety couplings (i.e., different perimeters/circumferences, shapes, sizes, and the like, of safety couplings). According to some embodiments, a bracket may be configured to be attached to a device or a component thereof positioned in vicinity to the safety coupling. As a non-limiting example, a safety coupling may be installed in vicinity to a wall, and a bracket may be configured to be attached to the wall.

According to some embodiments, bracket(s) 610 includes a circular shape, as depicted in FIG. 5. Alternatively, or additionally, in some embodiments, the bracket may include a wide variety of shapes, such as but not limited to, rectangular, hexagonal, D-shaped, and the like. According to some embodiments, the shape and the size of bracket 610 may be adjustable.

According to some embodiments, the shape and weight of the bracket do not affect the separation load of the safety coupling. For example, the weight of the bracket may be less than 20%, 15%, 10% or 5% of the weight of the valve thereby not affecting the separation load required for stopping the supply of fluid through the valve. For example, the bracket may weigh less than 100 gr for a safety coupling having a weight of 700 gr (not including pipes and screws). Optionally, the bracket is made of a light-weight material such as aluminum.

According to some embodiments, a first holder 622a (622a.1 and 622a.2) and a second holder 622b (622b.1 and 622b.2) (also referred to herein as “holders 622”) are detachably attached or fixed to each bracket 610 (610.1 and 610.2 respectively). It may be understood by skilled in the art that the number and the position of holders (i.e., first and second holders 622a and 622b) may vary.

According to some embodiments, a first optical sensor 620a (620a.1 and 620a.2) and a second optical sensor 620b (620b.1 and 620b.2) are attached to each of first holder 622a (622a.1 and 622a.2) and second holder 622b (622b.1 and 622b.2), respectively. In some embodiments, one optical sensor (e.g., first optical sensor 620a) attached to one holder may suffice for monitoring a safety coupling as discussed above.

According to some embodiments, each of first optical sensor 620a and second optical sensor 620b may be movable along each of first holder 622a and second holder 622b. For example, when glare is detected, any of first optical sensor 620a and second optical sensor 620b may change the position thereof by moving along each of first holder 622a and second holder 622b, thereby capturing images at a different angle (such that the glaze is minimized).

According to some embodiments, optical sensors 620a.1 and optical sensor 620b.1 are connected via a cable 630.1 through a first port 640.1 to a processing circuitry 650. According to some embodiments, optical sensors 620a.2 and optical sensor 620b.2 are connected via a cable 630.2 through a second port 640.2 to a processing circuitry 650. Additional connection ports 640 may be provided according to embodiments of the invention for connection of additional sub-systems as required. It is to be understood that in some embodiments, the optical sensors are connected via the cable to a power source and the image data is wirelessly transmitted to a cloud-based server, a processor, an additional system (e.g., an additional system such as system 600) and the like for further processing of the data. Optionally, the system operates with a battery and no cable (such as cables 630) for transfer of power is required. In some embodiments, processing circuitry 650 may process the image and transmit data to a cloud-based server.

According to some embodiments, processor 650 may be connected via an exit port 644 (e.g., USB, type C, and the like) to a power source, a database, a user interface, and the like, or any combination thereof in addition or instead of wireless transmission to a cloud server.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to case understanding of the specification and should not be construed as necessarily limiting.

What is claimed is:

1. A system for monitoring a safety coupling, the safety coupling comprising a visual failure indicator provided by a manufacturer thereof, the system comprising:
a processing circuitry configured for:
receiving image data from the at least one optical sensor, the image data including data of a region of interest of the safety coupling and devoid of the visual failure indicator of the safety coupling;
analyzing the image data to detect a change in a relative position between a first and a second part of the safety coupling;
evaluating health of the safety coupling by determining whether the detected change is a fault associated with a failure mode of the safety coupling;
outputting an indicator of said health of said safety coupling based on said evaluating.

2. The system of claim 1, wherein determining whether the detected change is a fault associated with a failure mode comprises classifying the severity of the change.

3. The system of claim 1, further comprising determining a probability of the fault to develop into a failure of the safety coupling.

4. The system of claim 1, further comprising calculating a trend or rate of the fault in developing into a failure of the safety coupling.

5. The system of claim 1, wherein one of the first and second parts of the safety coupling is static and the other part is dynamic, and wherein analyzing the image data comprises taking into account mobility of the dynamic part of the safety coupling.

6. The system of claim 5, wherein analyzing the image data comprises selecting a first point on the first perimeter and a second point on the second perimeter of the safety coupling, and calculating a distance between the first and the second point, to detect the change in the relative position.

7. The system of claim 6, further comprising re-selecting at least one of the first and the second points.

8. The system of claim 6, wherein the change in the relative position comprises a parallel displacement between the first perimeter and the second perimeter of the safety coupling.

9. The system of claim 6, wherein the change in the relative position comprises an angular change between the first perimeter and the second perimeter, or sections thereof.

10. The system of claim 1, wherein the system further comprises at least one sub system comprising:
at least one optical sensor configured to capture an image of said region of interest of the safety coupling for processing by said processing circuitry, wherein the region of interest comprises:
at least a portion of a first perimeter of a first part of the safety coupling and
at least a portion of a second perimeter of a second part of the safety coupling.

11. The system of claim 1, wherein the output indicator further comprises instructions configured to guide a user for taking appropriate measures.

12. A system for monitoring a safety coupling, the safety coupling comprising a visual failure indicator provided by a manufacturer thereof, the system comprising:
a processing circuitry configured for:
receiving image data of less than an entire perimeter of the valve from the at least one optical sensor;
analyzing the image data to detect a change in a relative position between a first and a second part of the safety coupling, wherein the image data is devoid of a visual failure indicator of the safety coupling;
evaluating health of the safety coupling by determining whether the detected change is a fault associated with a failure mode of the safety coupling,
outputting an indicator of said health of said safety coupling based on said evaluating.

13. The system of claim 12, wherein the image data of less than an entire perimeter of the valve comprises image data of about 10% to about 50% of the entire perimeter of the safety coupling.

14. The system of claim 12, wherein determining whether the detected change is a fault associated with a failure mode comprises classifying the severity of the change.

15. The system of claim 12, further comprising determining a probability of the fault to develop into a failure of the safety coupling.

16. The system of any claim 12, further comprising calculating a trend or rate of the fault in developing into a failure of the safety coupling.

17. The system of claim 12, wherein the system further comprises at least one sub system comprising:
at least one optical sensor configured to capture an image of said region of interest of the safety coupling for processing by said processing circuitry, wherein the region of interest comprises:
at least a portion of a first perimeter of a first part of the safety coupling and
at least a portion of a second perimeter of a second part of the safety coupling.

18. The system of claim 12, wherein the output indicator further comprises instructions configured to guide a user for taking appropriate measures.

19. The system of claim 12, wherein the safety coupling is a fuel breakaway valve.

20. A vehicle comprising a plurality of systems according to claim 12.
